(19) United States
(12) Patent Application Publication
(10) Pub. No.: US 2021/0365445 A1
(43) Pub. Date: Nov. 25, 2021

(54) TECHNOLOGIES FOR COLLECTING, MANAGING, AND PROVIDING CONTACT TRACING INFORMATION FOR INFECTIOUS DISEASE RESPONSE AND MITIGATION

(71) Applicant: FORTIOR SOLUTIONS, LLC, Hillsboro, OR (US)

(72) Inventors: James Frederick ROBELL, Beaverton, OR (US); Qui Quoc HOANG, Portland, OR (US); Viet Quoc HOANG, Portland, OR (US); Maria thanh NGUYEN, Portland, OR (US); Erin Maria HANG, Portland, OR (US)

(73) Assignee: FORTIOR SOLUTIONS, LLC, Hillsboro, OR (US)

(21) Appl. No.: 17/330,196

(22) Filed: May 25, 2021

Related U.S. Application Data
(60) Provisional application No. 63/029,650, filed on May 25, 2020.

(51) Int. Cl. G06F 16/245; H04L 29/08; G06K 19/06

(52) U.S. Cl. CPC G06F 16/245; G06K 19/06037; G06K 19/06028; H04L 67/22

(57) ABSTRACT

Disclosed embodiments are related to technologies for the provision of contact tracing services (CTS) in an affordable and non-intrusive means for individuals to check in and check out of gathering places so that their contact information can be stored and made available to contact tracers. A gathering place operator scans a machine-readable element (MRE) of a contact tracing participant that enters or exits the gathering place. The MRE encodes a unique identifier (UID) generated by the CTS for the participant, and the scan captures the UID along with a location and a timestamp at entry or exit of the gathering place. The UID, location, and timestamp are provided to the CTS for storage in a contact tracing database, which is used for providing contact tracing information to contact tracers. Other embodiments may be described and/or claimed.

### RELATED APPLICATIONS

The present application claims priority to U.S. Provisional App. No. 63/029,650, filed on May 25, 2020, the contents of which is hereby incorporated by reference in its entirety.

### FIELD

The present disclosure generally relates to the fields of computing and data processing, and in particular, to digital contact tracing technologies.

### BACKGROUND

The background description provided herein is for the purpose of generally presenting the context of the disclosure. Unless otherwise indicated herein, the materials described in this section are not prior art to the claims in this application and are not admitted to be prior art by inclusion in this section.

The spreading of a communicable disease at the community, regional, and/or global level can lead to detrimental health effects for individuals who have had or continue to have interactions with infected individuals. One way of stemming the spread of diseases is to identify individuals who have had contact with infected individuals (“contacts”). This allows the contacts to be notified in a timely manner that they may have been exposed to an infectious disease and, if applicable, to be tested for the disease, receive treatment for the disease (if available), and take precautionary measures to reduce the likelihood of further spreading the disease. For example, coronavirus disease 2019 (COVID-19), caused by severe acute respiratory syndrome-coronavirus 2 (SARS-CoV-2), has potential for a long-lasting global pandemic, high fatality rates, incapacitated health systems and tremendous economic impact. Until vaccines are widely available, the only available infection prevention approaches are case isolation, quarantine, physical distancing, decontamination, hygiene measures, and contact tracing.

Contact tracing is the process of identifying individuals who may have come into contact with an individual infected with a disease (“contacts”) and subsequent collection of further information about their contacts. Contact tracing is foundational to infection control as it allows for timely notification and, if applicable, testing for the disease, treatment for the disease (if available), informed isolation and quarantine of individuals or animals who have come into contact with the communicable disease and would then have the potential to spread the disease. With the outbreak of the COVID-19 pandemic, there has been interest in using mobile application and wireless communication technologies to perform contact tracing.

Most existing and proposed contact tracing solutions are extremely intrusive to the privacy of individuals. For example, SafeEntry™, provided by the government of Singapore, is a digital check-in system that logs the names, National Registration Identity Cards (NRICs) or Foreign Identification Numbers (FINs), and mobile numbers of individuals visiting public places to facilitate contact tracing efforts. SafeEntry is used for data collection from individuals at entry/exit points through an individual's scanning of a business's unique QR code displayed at the business's location, or through the business scanning the barcode of an individual's identification card (e.g., NRIC, driver's license, student pass, or work permit). In SafeEntry™ all data is stored by the government and individuals do not have a choice in whether to disclose these data items. Other proposed contact tracing solutions are reported to use GPS, cellular data, and other proximity tracking technologies including those that monitor, on a continuous basis, the geolocation and relative proximity of individuals' mobile devices. Undue privacy intrusions may deter many individuals from participating in such a contact tracing program thereby reducing the effectiveness of that program from controlling the spread of a disease.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates an example system architecture for practicing the embodiments discussed herein.

FIGS. 2 and 3 illustrate example contact tracing data flows according to various embodiments.

FIG. 4 illustrates example contact tracing user interfaces according to various embodiments.

FIGS. 5, 6, and 7 illustrate an example process for practicing the embodiments discussed herein.

FIGS. 8, 9, and 10 illustrate additional examples processes for practicing the embodiments discussed herein.

FIG. 11 illustrates an example computing system suitable for practicing various aspects of the present disclosure in accordance with various embodiments.

FIG. 12 illustrates an example neural network suitable for practicing various aspects of the present disclosure in accordance with various embodiments.

FIG. 13 illustrates an example non-transitory computer-readable storage media that may be suitable for use to store instructions (or data that creates the instructions) that cause an apparatus, in response to execution of the instructions by the apparatus, to practice selected aspects of the present disclosure.

### DETAILED DESCRIPTION

Embodiments described herein include technologies for the provision of contact tracing services. The contact tracing services provide an affordable, very low intrusive (from a privacy perspective), multi-lingual, multi-cultural, quick, “no touch” means for individuals to electronically check in and/or check out at restaurants, grocery stores, personal care service locations, and other businesses, venues, facilities, locales, and/or other gathering places (collectively referred to as “gathering places” or the like) so that their contact information, and their date/time of entry and/or exit can be temporarily stored and made available to public health authority contact tracers or other authorized personnel in the event of a need to contact the individuals because of possible exposure to a communicable disease such as COVID-19. The contact tracing embodiments discussed herein solve the problem of individuals having to manually sign in and provide their contact information to operators of a gathering place or establishment. Such a manual process is time-consuming, may necessitate physical contact with the other individuals (e.g., touching a sign-in sheet or a writing instrument), risks loss or compromise of the sign-in information thereby jeopardizing individual privacy and timely notification, and opens the door for businesses to use collected information for purposes other than contact tracing (e.g., sending coupons or other promotional pitches to individuals, or selling individuals' information to third party marketing organizations). This also prevents individuals from practicing safe social-distancing from other individuals at a gathering place.

The contact tracing embodiments allow owners, agents, workers, employees, volunteers, or other individuals (“operators”) of gathering places to electronically “no touch” scan unique identifiers (UIDs) of contact tracing participants that enter and exit their gathering places. The scanned unique IDs and/or contact information is/are captured along with location, date, and time of entry and/or exit of the gathering place. In these embodiments, the scanned UIDs are provided to the contact tracing service for storage in a contact tracing database (DB), which is used for providing contact tracing information to contact tracers and/or other approved entities or individuals, to provide timely notification to and to provide appropriate follow-up to potentially exposed individuals (including gathering place customers, owners, and operators). As used herein, the term “contact tracer” refers to a person, organization (org), or entity that is permitted or authorized to perform contact tracing related tasks such as identifying an infected individual's potential contacts, and alerting those potential contacts about the details of possible infection. Contact tracers typically are employed by or are the agents of federal, state, regional, local or tribal public health authorities, or private entities.

The embodiments allow contact tracers to perform automated searches for a specific case subject's (e.g., an infected individual) potential contact history based on the UID entry/exit scans discussed previously. Search results are electronically generated to enable contact tracers to identify potential contacts of a case subject, and notify the potential contacts of a potential exposure to a communicable disease. The potential contacts are individuals whose UIDs were scanned at the relevant gathering places during the relevant time period(s) to that of the case subject, as well as the gathering place operators, employees and/or other individuals associated with a gathering place. The contact tracing service/system also provides mechanisms to handle customer service and/or system services for searching the contact tracing DB including, for example, user authentication/verification (e.g., login, PIN/password (re)sets), report assistance, name changes, location changes, billing issues, and other customer related services.

In embodiments, the UIDs are “low intrusive” identifiers that do not contain or otherwise disclose an individual's personal information (sometimes referred to as “personally identifying information” or “PII”) or the like. For example, the contact tracing embodiments discussed herein do not require the collection of biometric data, GPS data, or wireless network/signaling (e.g., cellular, WiFi, NFC, Bluetooth, etc.) data. Additionally, the contact tracing embodiments do not push advertising or marketing information to individual participants. In some embodiments, the contact information and/or UIDs may be limited to an email address and/or phone number. However, in other embodiments, personal information/PII and/or other data elements such as name, date of birth (DOB), home or employment address, social security number (SSN), driver's license or other ID number, demographic data, etc., may additionally or alternatively be collected and stored in association with the UID. The number and types of data elements included in the UID/contact information may be specific to the communicable disease being traced, and as such, may vary from embodiment to embodiment.

The contact tracing embodiments discussed herein collectively provide an affordable, low intrusive (from a privacy perspective), multi-lingual, multi-cultural, low friction, “no touch”, easily adoptable capability for contact tracers and other approved parties to provide much more timely, accurate, efficient and effective notification of infectious disease exposure to affected individuals and gathering places.

### 1. Contact Tracing Embodiments

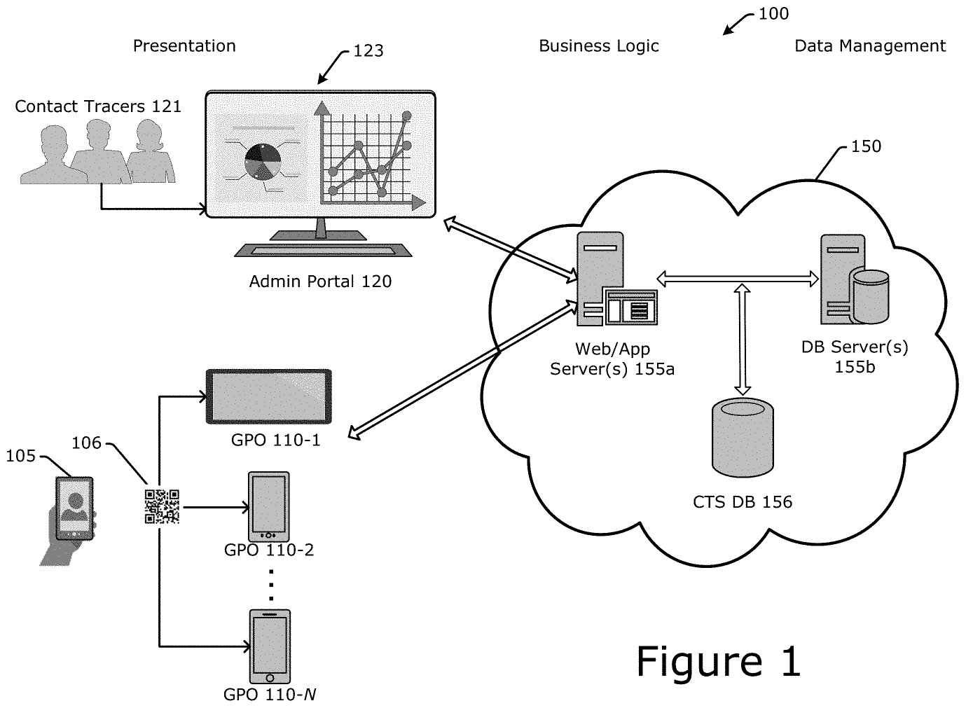

FIG. 1 depicts an example system architecture 100 for providing contact tracing services (CTS) according to various embodiments. In this example, a CTS 150 includes a CTS database (DB) 156 and one or more servers 155 including one or more web/application servers 155a and one/or more DB servers 155b (collectively referred to as “servers 155” or the like). The servers 155 operate distributed applications to provide the CTS 150 to user systems 105, gathering place operators (GPOs) 110-1 to 110-N(where N is a number), and contact tracers 121. The servers 155 may be located in one or more data centers, at the network's “edge”, or in some other arrangement or configuration. In some embodiments, one or more of the servers 155 may be virtual machines (VMs) or other isolated user-space instances provided by a cloud computing service or the like. Furthermore, the CTS servers 155a may also provide various administration capabilities to support the various aspects discussed herein. The servers 155a receive GPO 110 information (e.g., contact information and locations) collected by a front-end CTS portal (e.g., mobile app and/or website); receive individual user information (e.g., contact information, etc.), which is also collected by a front-end CTS portal (e.g., website, mobile app, etc.). The servers 155b update database 156 with new/updated information, and may be configurable to destroy information within a predefined or configurable period of time. The servers 155 are also configurable or operable to generate reports and statistics to authorized recipients upon request.

Individuals register or enroll with the CTS 150 by providing information to the CTS 150 using a user system 105 (hereinafter a “user 105”, “participant 105”, “individual 105”, or the like may be used interchangeably throughout the present disclosure and may also refer to the user system 105 and/or a user of that user system 105). For example, a web/app interface may be provided to the user system 105 to access a web/app server 155a to provide the information to the CTS 150, which is then stored by the DB server(s) 155b.

In various embodiments, a minimal amount of PII is collected, for example, only contact information for the user 105 such as an email address, phone number, and/or the like. In some implementations, the user 105 may provide other types of identifying information such as their name, home or employment address, and the like. The user device 105 may be a mobile device such as a smartphone, tablet computer, wearable (e.g., smartwatch), and/or the like. Additionally or alternatively, the web site/app interface may collected some PII from a registering user such as the user's 105 network address, a cookie ID, a timestamp of when the user visited or accessed the registration website/web app, and/or geolocation information associated with the user's 105 access of the registration website/web app. This information may be collected by program code/script embedded in the registration webpages/web apps, which when executed by the user system 105, causes the user system 105 to collect such data and send it to the CTS 150. Additionally or alternatively, sensitive data and/or confidential information may be collected. As discussed in more detail infra, the personal, sensitive, and/or confidential data are anonymized and/or pseudonymized or otherwise de-identified using suitable anonymization/pseudonymization technique(s).

After the registration/enrollment process, the user 105 receives a UID, which is encoded in a machine-readable element (MRE) 106. In some implementations, the user system 105 may simply receive an MRE 106 with an encoded UID (e.g., from the CTS 150). In alternative implementations, the user system 105 may obtain the UID and generate the MRE 106. For purposes of the present disclosure, the MRE 106 may be referred to as a UID 106 or the like, even though these terms refer to different concepts. GPOs 110-1 to 110-N (collectively referred to as “GPO 110” or “GPOs 110”) also register with the CTS 150 using GPO system(s) 110 (hereinafter “GPOs 110” or the like may refer to the GPO systems 110 and/or users of the GPO systems 110) in a same or similar manner as the user 105 participants, which enables the GPOs 110 or their agents/employees to scan the MREs 106 of user 105 contact tracing participants when they enter and/or exit the gathering place. Additionally or alternatively, GPOs 110 can register multiple gathering places (e.g., multiple locations of a chain restaurant or the like) and/or can register to serve as a GPO 110 for multiple facilities (e.g., multiple gathering places owned or operated by different organizations (orgs) or entities) with their sponsorship, account, or profile. In some embodiments, the GPOs 110 and/or the user 105 may be required to pay a fee during the registration process to enroll with the CTS 150.

After the MRE 106 is generated and/or obtained, the user 105 presents the MRE 106 when entering and/or exiting a gathering place. In some implementations, the user 105 may open a specific contact tracing application (app) to present the MRE 106, while in other implementations, the user 105 may simply open a suitable information object that includes the MRE 106 (e.g., a PDF, JPEG, GIF, email, etc.). MREs 106 may be scanned not just at entry and/or exit of facility or gathering place, but also at entry and/or exit of containment areas and entry and/or exit of other “zones”. Additionally, the GPO 110 may also have to log into a contact tracing app to scan the MRE 106. When GPO 110 is registered as a multi-gathering place GPO 110, the GPO 110 may be required to sign-in to the contact tracing service for a particular gathering place, or the contact tracing app may require the GPO 110 to select the applicable gathering place in a list of gathering places registered to that particular GPO 110.

The GPOs 110 may use any suitable apparatus to scan the MRE 106. In the example implementation shown by FIG. 1, the MRE 106 is a quick response (QR) code (hereinafter “QR 106”) that contains information about the user 105, such as the aforementioned UID. When the GPOs 110 register with the contact tracing service, the GPOs 110 receive a CTS mobile app that enables them to scan the MREs 106 of user 105 contact tracing participants 105 when they enter and exit the gathering place. For example, the CTS mobile app may invoke a camera driver or API for accessing a camera of the GPO device 110. When MREs 106 are scanned by the CTS mobile app, the CTS mobile app gets updated instantly and can be seen on the CTS portal. In some embodiments, the CTS mobile app operated by the GPO device 110 may collect location information of the GPO device 110 (e.g., GPS coordinates, LTE location services, etc.), which may be provided to the CTS 150 along with the UID of the scanned MRE 106.

The QR 106 comprises an arrangement or pattern of black squares arranged in a square grid on a white background, which can be read by an imaging device such as a camera or other like sensor embedded in or otherwise accessible by a mobile device (e.g., smartphone, tablet computer, etc.), and processed using error correction until the image can be appropriately interpreted. In other embodiments, other color schemes and/or shapes may be used for the MRE/QR 106.

In practice, QR codes often contain data for a locator or resource address (e.g., a uniform resource locator (URL)), identifier (e.g., UID 106), or web tracker that points to a website or app (e.g., a web app or the like). This information may be encoded in the QR 106 using numeric, alphanumeric (string or char), byte, binary, hexadecimal, and/or kanji data types. When the GPOs 110 scan the user's 105 QR 106, the CTS mobile app processes and interprets the QR 106. Once interpreted, the UID is extracted from the patterns/arrangement that are present in both horizontal and vertical components of the QR 106. Then, the CTS mobile app may send an indication or other like message to the CTS 150 to record the entry and/or exit of the user 105 from the gathering place. The gathering place entry and/or exit scans are recorded into the CTS DB 156 by the DB servers 155b. To protect the privacy of user 105 participants, the CTS DB 156 is inaccessible by the GPOs and their devices 110.

In some implementations, the QR 106 may be a model 1 QR code, a micro QR code, a secure QR code (SQR), a Swiss QR code, an IQR code, a frame QR code, a High Capacity Colored 2-Dimensional (CC2D) code, a Just Another Barcode (JAB) code, and/or other QR code variants. In other implementations, rather than using a QR 106, the MRE 106 may be a linear barcode (e.g., Codablock F, PDF417, code 3/9 (or Alphas39, Code 3 of 9, etc.), Universal Product Code (UPC) bar code, CodaBar, etc.), Electronic Bar Code (EPC) as defined by the EPCglobal Tag Data Standard, EPC RFID tag, data matrix code, DotCode, Han Xin code, MaxiCode, SnapTag, Aztec code, SPARQCode, Touchtag, Codablock F, GS1 DataBar, and/or other like machine-readable element.

In other implementations, the MRE 106 may be some other image type that encodes the UID using, for example, a watermark or steganographic techniques. In other implementations, the MRE 106 may be printed on paper, or printed on a wearable article (e.g., bracelet, necklace charm, or the like). In either of these implementations, the GPOs 110 may use a CTS mobile app to scan the MRE 106 in a same or similar manner as discussed previously. In other implementations, a barcode reader or some other optical device may be used to scan the MRE 106.

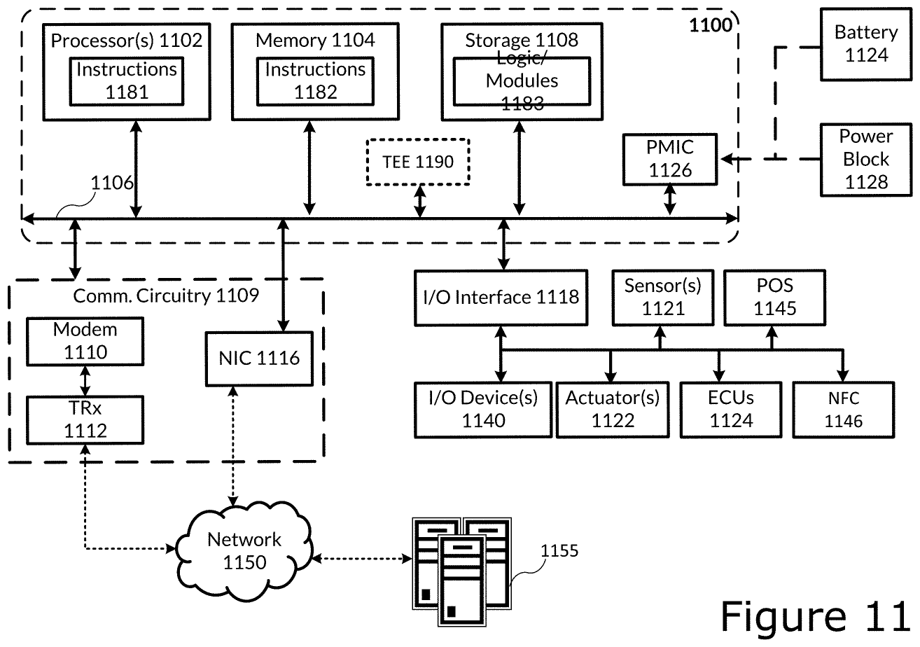

In another example implementation, near-field communication (NFC) technology may be used, where an NFC device in the user system 105 (e.g., NFC circuitry 1146 of FIG. 11) communicates the UID to an NFC device in the GPO device 110, which may then be provided to the CTS mobile app previously discussed or otherwise provided to the CTS 150 for recordation. Usually, NFC devices require a dedicated antenna, an NFC controller, and a secure element. The secure element could be a separate universal integrated circuit card (UICC) or subscriber identity module (SIM) card coupled with the NFC controller, a Trusted Platform Module (TPM) or trusted execution environment (TEE) communicatively coupled to the NFC controller, or an IC embedded in the NFC controller. Typically, the secure element stores payment credentials and performs cryptographic operations. Furthermore, an applet residing in the secure element usually receives NFC event notifications from the NFC controller and provides the NFC event notifications to authorized apps operated by the host architecture (e.g., a point of sale (POS) app, a banking app, a wallet app, the CTS mobile app, and/or the like). The applet may also emulate a passive smart card, for example, a credit card with an EMV chip. This emulation of a passive smart card may enable a user to perform transactions as if the computing device were a contactless card. In NFC implementations, a CTS applet may be stored in the secure element, which provides the UID to a GPO device 110 via the NFC device, or sends the UID to the CTS 150 when the NFC device obtains the UID from the user device 105. Other NFC systems provide services that emulate the physical secure element (referred to as “Host Card Emulation” or “HCE”). In most HCE systems, the secure element functions (e.g., payment credential storage and cryptographic operations) are implemented by a cloud service separate from the NFC-enabled device. In these NFC implementations, the HCE cloud app may provide the UID to the CTS 150 without having the UID being accessed by the GPO device 110.

In other implementations, the user device 105 and/or GPO device 110 may use Bluetooth or Bluetooth Low Energy (BLE) to exchange the user's 105 UID. For example, the GPOs may deploy a Bluetooth/BLE beacon that broadcasts one or more Bluetooth/BLE signals, which indicate that contact tracing services are employed at that gathering place. When the user system 105 obtains the one or more Bluetooth/BLE signals, the user system 105 may automatically provide the UID to the beacon, which may then relay the UID to the CTS 150 via a wired or wireless connection. Alternatively, the user system 105 may output a notification or otherwise prompt the user 105 to provide the UID or permission to share the UID with the beacon. In some implementations, these beacons may be (or may be replaced with) Internet of Things (IoT) devices/sensors for automated scanning of MREs 106 at gathering place entrances and exits and/or designated “zones”. For example, an IoT device or autonomous sensor may be configured to scan for MREs within a designated zone (e.g., a designated room, a section of a hallway or corridor, a predefined boundary, or the like). These designated zones may be gather place entrances and/or exits, waiting areas, or any other area or region. Additionally or alternatively, the MRE 106 may be a radio-frequency identification (RFID) tag or some other low-cost passive device with limited memory capacity with the UID encoded or otherwise stored therein. In these implementations, an electromagnetic interrogation pulse emitted from a nearby RFID reader device triggers the RFID tag to transmit digital data including the UID back to the RFID reader. The RFID reader may be a human operated device or an autonomous or semi-autonomous sensor (e.g., IoT device or the like). Other unmanned and/or automated scanning techniques may be used in other embodiments.

Scanning zones can be used to segment a gathering place into multiple areas to scan MREs 106. This feature is useful for larger (in terms of area or size) gathering places. contact tracers may be able to better pinpoint where individuals may have been exposed when more scanning zones are set up in a particular gather place. The GPO 110 may decide whether to establish multiple scanning zones, and where to place the different scanning zones throughout the gathering place. For relatively small gathering places, such as a restaurant, nail salon, or boutique store, only one scanning zone may be needed. In another example where the gathering place is an office building, individual floors, the building's lobby, café, gym, individual conference rooms, or other like areas may be designated as separate scanning zones. In another example where the gathering place is an educational institution (e.g., a high school or university), different buildings or individual class rooms can be set up as respective scanning zones. In another example where the gathering place is a stadium, arena, or entertainment venue, different scanning zones can be assigned to respective seating sections or levels. In either of these embodiments or examples, the GPO 110 (or agent/employee of the GPO 110) may log into the CTS platform via the CTS app/portal to designate or assign the different scanning zones to different areas or sections of their gathering place(s). In these implementations, the CTS app/portal may include an option to manage gathering place(s) (e.g., a menu or dashboard), which provides for the selection of different zones as well as to enter or add various zone details. In these implementations, when a participant 105 has their MRE 106 scanned at or near a particular zone, the CTS 150 will record the entry/exit at the specified zone.

In any of the aforementioned embodiments/implementations, the UID may be any value or data structure that uniquely identifies an individual and/or their user system 105. In one embodiment, the UID may be a randomly generated number or string, which may be generated using a suitable random number generator, pseudorandom number generators (PRNGS), and/or the like. For example, the UID may be a version 4 Universally Unique Identifier (UUID) that is randomly generated according to Leach et al., “A Universally Unique IDentifier (UUID) URN Namespace”, Internet Engineering Task Force (IETF), Network Working Group, Request for Comments (RFC): 4122 (July 2005) (“[RFC4122]”), which is hereby incorporated by reference in its entirety. In one example implementation, the random UID is generated for an individual 105 upon completing the registration process.

In another embodiment, the UID may be a hash value calculated from one or more inputs (which may or may not be unique to the individual/user system 105). In one example implementation, the UID may be generated using the supplied contact information (or a portion thereof) as an input to a suitable hash function (e.g., such as those discussed herein). For example, the UID may be a version 3 or 5 UUID that is generated according by hashing a namespace identifier and name using MD5 (UUID version 3) or SHA-1 (UUID version 5) as discussed in [RFC4122]. In another example, the UID may be generated using any suitable hash function and using any combination of PII and/or device or system information supplied by a user and/or extracted from the user system 105 during the CTS registration process.

In another embodiment, the UID may be a digital certificate supplied by a suitable certificate authority, or may be generated using the digital certificate (e.g., hashing the digital certificate). In another embodiment, the UID may be a specific identifier or may be generated using the specific identifier (e.g., as discussed previously). The specific identifier may be any suitable identifier associated with a user and/or user system 105, associated with a network session, an application, an app session, an app instance, an app-generated identifier, and/or some other identifier (ID). The specific identifier may be a user ID or unique ID for a specific user on a specific client app and/or a specific user system 105. Additionally or alternatively, the user ID may be or include one or more of a user ID (UID) (e.g., positive integer assigned to a user by a Unix-like OS), effective user ID (euid), file system user ID (fsuid), saved user id (suid), real user id (ruid), a cookie ID, a realm name, domain ID, logon user name, network credentials, social media account name, user session ID, and/or any other like ID associated with a particular user or system 105. Additionally or alternatively, the specific identifier may be a device identifier such as a device ID, product ID/code, serial number of the user system 105, a document of conformity (DoC), and/or the like. Additionally or alternatively, the specific identifier may be a network ID such as an international mobile subscriber identity (IMSI), internet protocol (IP) address, and/or some other suitable network address such as those discussed herein. Any of the aforementioned identifiers and/or information may be combined to produce the UID, and/or other information, such as the information discussed infra, may be used to produce the UID.

In another embodiment, the UID may be a device fingerprint of the user system 105. The device fingerprint may be any information collected about the software and hardware of a computing device for the purpose of identification, which may or may not be incorporated into an identifier (e.g., the aforementioned UID or the like). In one example implementation, the device fingerprint may be based on system data, sensor data, and/or the like that is/are collected and combined using some known mechanism (e.g., a hash function or the like). In another example implementation, the device fingerprint may be the output of a physical unclonable function (PUF) implemented by a tamper-resistant chipset in the user system 105 (e.g., TEE 1190 of FIG. 11 discussed infra). When a physical stimulus (e.g., electric impulse) is applied to the PUF, it may react in an unpredictable way due to the complex interaction of the stimulus with the physical microstructure of the PUF. This exact microstructure may depend on physical factors introduced during manufacture which may be unpredictable. The PUF outputs the device fingerprint that may serve as the UID. Any of the aforementioned embodiments/implementations may be combined.

In another embodiment, the UID could be biometric data, such as a face scan, palm scan, eye scan, fingerprint, voiceprint, ECG data and/or the like. In one example implementation, the biometric data may be encrypted or encoded to protect the user's 105 privacy.

In one example, registration may be limited to individuals who are at least 18 years of age. These individuals 105 self-register through a website or mobile app operated by the user device 105. In this example, children between the ages of 13-17 may obtain an MRE 106, but they may do so only through a parent or legal guardian who is the registrant 105. In this case, the child's MRE 106 is still associated with a different UID than the parent's UID. The child's UID may be associated with the same contact information as the parent/guardian, or unique contact information that is different than the parent/guardian contact information. For example, if a mother registers herself and three of her minor children (between the ages of 13-17) and the contact information is in the form of an email address, she may provide a total of four email addresses, one email address for each MRE 106. Additionally or alternatively, when a parent/legal guardian registers themselves as well as their minor children, the parent/legal guardian can use their own email address for themselves and for each of their minor children they register. The parent/legal guardian designates which minor is associated with each MRE 106. Additionally or alternatively, children under the age of 13 may or may not participate in the CTS 150.

If a participating user 105 has a registered MRE 106 but does not have it with them when they are about to enter and/or exit a gathering place (e.g., because the user 105 forgot to bring their mobile phone), the GPO 110 can manually enter the user's 105 UID or contact information associated with the MRE 106 to record the user's 105 entry/exit of the gathering place. If a user 105 does not have a registered MRE 106 but would like to register upon arrival at a gathering place, the user 105 can be registered on the spot using their own user device 105, or using a GPO device 110.

Registered users 105 elect to have their MRE 106 scanned at registered gathering places to get notification from contact tracers 120 or other authorized parties about possible exposure to a communicable disease. GPOs 110 can enroll walk-in users 105 if they choose to do so, and an MRE 106 will be issued on the spot. Registered users 105 elect to have their MRE 106 scanned when exiting the registered gathering place. The MRE 106 is designed to be used at any and all registered gathering places. In some implementations, the MRE 106 and an individual's 105 log/file may be removed from the CTS 150 upon user request. In some implementations, all logs/files are destroyed on an ongoing basis at a predetermined interval.

Contact tracers 121 use an administration terminal 120 (hereinafter a “contact tracer system 120”, “terminal 120”, “admin portal 120”, or the like may refer to the terminal 120 and/or individual users 121 of the terminal 120) to access the CTS 150. Contact tracers 121 register with the CTS 150 in a same or similar manner as the user 105 and GPOs 110 discussed previously. Although this example shows the terminal 120 as a desktop personal computer or a workstation, the terminal 120 may be any type of client device/system, such as those discussed herein. The contact tracers 120 are verified by the CTS 150, and if appropriate, are approved to access to the CTS 150 entry/exit history stored in the CTS DB 156. The contact tracers 121 may use the entry/exit history of a case subject (e.g., infected person) to identify and contact individuals who may have been in close proximity or contact with the case subject (“contacts”). In some embodiments, the contact tracers 120 may also have to pay a fee to gain access or register with the CTS 150.

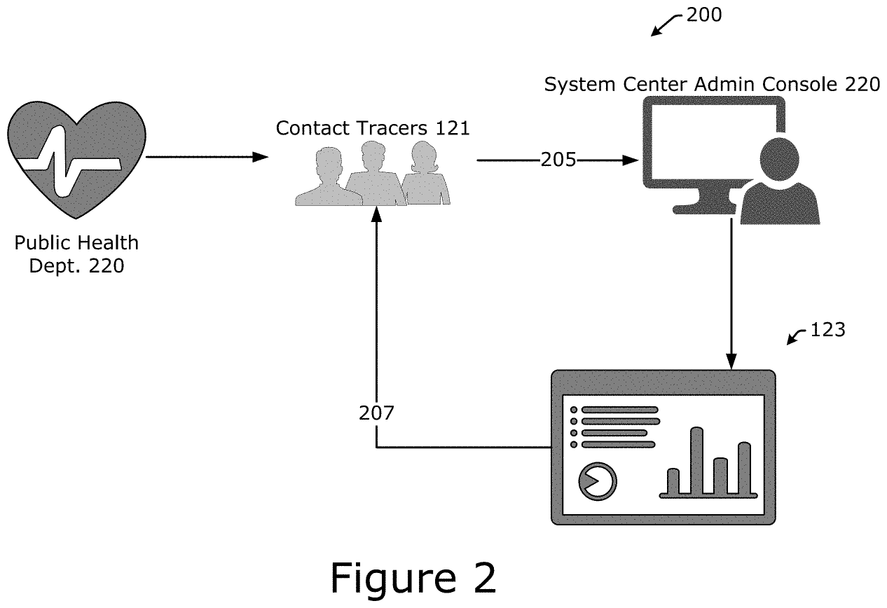

FIG. 2 depicts an example contact tracing model 200 according to various embodiments. The contact tracing model 200 shows a logical flow of the contact tracing service 150. In FIG. 2, a public health authority (PHA) 220 (or similar regulatory body or enterprise) employs or otherwise engages contact tracers 121. The contact tracers 121 can submit a query 205 to the CTS 150 to obtain the contact history of a particular case subject. In one example, to submit the query 205, the contact tracers 121 may scan the case subject's MRE 106 in a same or similar manner as the GPOs 110 discussed previously. In another example, the contact tracers 121 may enter the UID or other identifier of the case subject into a search interface (e.g., web app or the like) to submit the query 205.

The query may be submitted 205 through an administrator (admin) portal 120. The admin portal 120 allows the contact tracers 121 to view and/or obtain contact data, perform various housekeeping tasks, and generate various reports 123 and/or statistics. The reports 123 can be used to identify potentially infected persons as well as to identify outbreaks of a communicable disease at various locations such as at participating gathering places. In various embodiments, the dashboard/reports 123 may be generated to include various visual representations of the contact tracing data, such as charts, graphs, heat maps, and the like, as specified by the contact tracer 121. In various embodiments, the query 205 may be obtained and processed by the CTS server(s) 155, which may then execute the query 205 using a suitable query engine, such as any of those discussed herein. In these embodiments, the query engine may compile the reports 123 in response to executing the query 205. In some implementations, CTS 150 personnel may obtain the query 205 and run the query 205 against the CTS DB 156 to generate the MRE code scan activity report 123. In these implementations, the CTS server(s) 155 and/or the CTS personnel may send the report 123 via encrypted email or through other digital means to the contact tracer 121. Additionally or alternatively, the CTS 150 may employ various Artificial Intelligence (AI) and/or Machine Learning (ML) techniques including Natural Language Processing (NLP) and/or Natural Language Understanding (NLU) techniques to process queries and generate reports 123. The CTS 150 returns 207 viewable/downloadable search results in the form of a contacts report 123.

The contacts report 123 may include the entry/exit times and dates at various GPOs 110 of potential contacts of the case subject, as well as contact information for the GPOs 110 and/or the potential contacts. The contact tracers 121 may then contact the potential contacts and/or the GPOs 110 to inform them of their potential exposure to the communicable disease carried by the case subject. The contacts report 123 may also include or indicate who and how many contacts have been exposed or potentially infected, where and when they were exposed and/or potentially infected; how many contacts stay where, how long, and how often; which gathering places have the most infected (or potentially infected) individuals; and how far and how soon an infected person spreads the communicable disease.

In some embodiments, the CTS 150 provides contacts report 123 to individual GPOs 110 and/or personnel at a particular gathering place, rather than a PHA 220 if the GPOs 110 have opted-in to perform contact tracing themselves rather than having the PHA 220 performing the contact tracing. As examples, GPOs 110 and/or individual employees/agents at a particular gathering place that may perform contact tracing themselves may include school nurses or administrators who conduct contact tracing at schools; corporate human resources (HR) personnel who conduct contact tracing at a corporate site; and police and/or firefighters performing contact tracing for city employees. In other words, a gathering place agent/employee can serve in the dual role of both a GPO 110 (or GPO 110 agent/employee) and a contact tracer 121 (e.g., through its personnel, agent(s), and/or employee(s)). These embodiments may be useful for cases where PHAs 220 are too beleaguered to keep up with the demand for contact tracing, which may be the case during a world-wide pandemic such as the COVID-19 pandemic. In these situations, it has become increasingly acceptable for gathering places, through their agent(s), and/or employee(s) to do their own contact tracing rather than waiting for PHAs 220 to perform contact tracing.

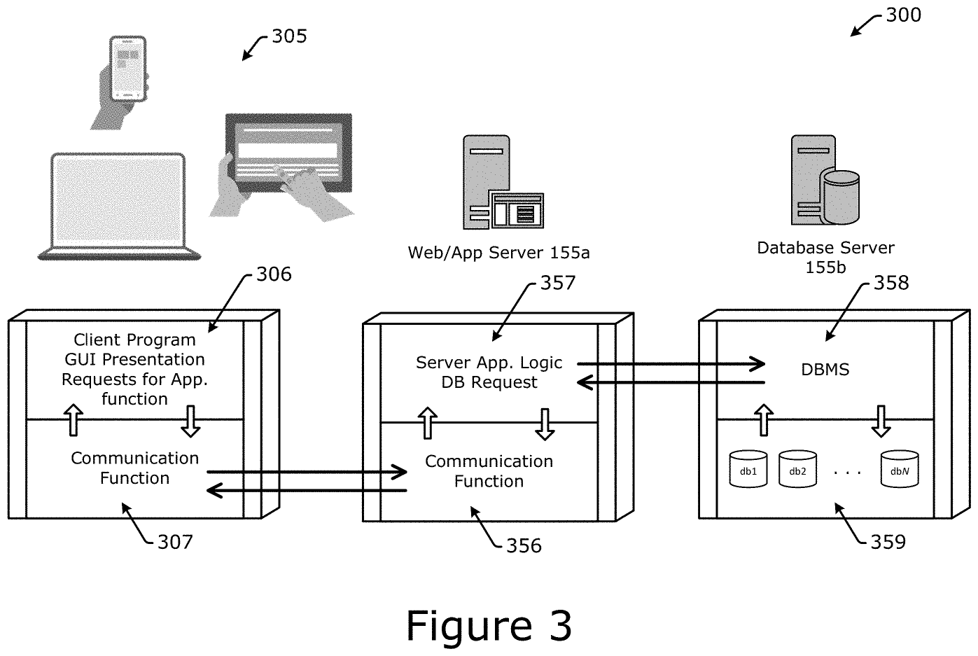

FIG. 3 depicts an example data flow for the CTS 150 according to various embodiments. In this example, various clients 305 (which correspond to the user system 105, GPO system 110, and/or the terminal 120 of FIG. 1) provides/operates a client program that includes a presentation layer 306 that displays a graphical user interface (GUI) that allows a user of the client device 305 to interact with the client device 305. The presentation layer 306 interfaces with a communication function (commFxn) 307 to provide data/information to the web/app server 155a. The commFxn 307 interfaces with a commFxn 356 of the web/app server 155a to provide the collected data to the web/app server 155a. The web/app server 155a also operates a server program 357 including app logic to send DB requests to a DB management system (DBMS) 358 implemented by the DB server 155b. This interaction may take place using a suitable communication protocol or the like. The app logic may generate the DB requests using a suitable DB query language implemented by the DBMS 358, such as any of those discussed herein. The DBMS 358 interfaces with a DB tier 359 to store and/or retrieve data in various data store systems/devices. The retrieved data may be returned to the server program 357, which then formats the obtained data into a format consumable by the client 305 and the commFxn 356 sends the consumable data to the commFxn 307 in the client 305. The commFxn 307 provides the data to presentation layer 306 for display.

The CTS 150 facilitates streamlined and privacy-conscious contact tracing and allows users 105 to engage in in-person activities with the confidence that if they get exposed to a communicable disease (e.g., COVID-19), they can be notified quickly and while protecting their privacy by having provided a minimal amount of personal information. Users 105 with whom the subject cases have had contact and businesses, venues, facilities, and gatherings they visited likewise can be notified by public health authority contact tracers 121 or other authorized parties that they may have been exposed to COVID-19 or other infectious disease.

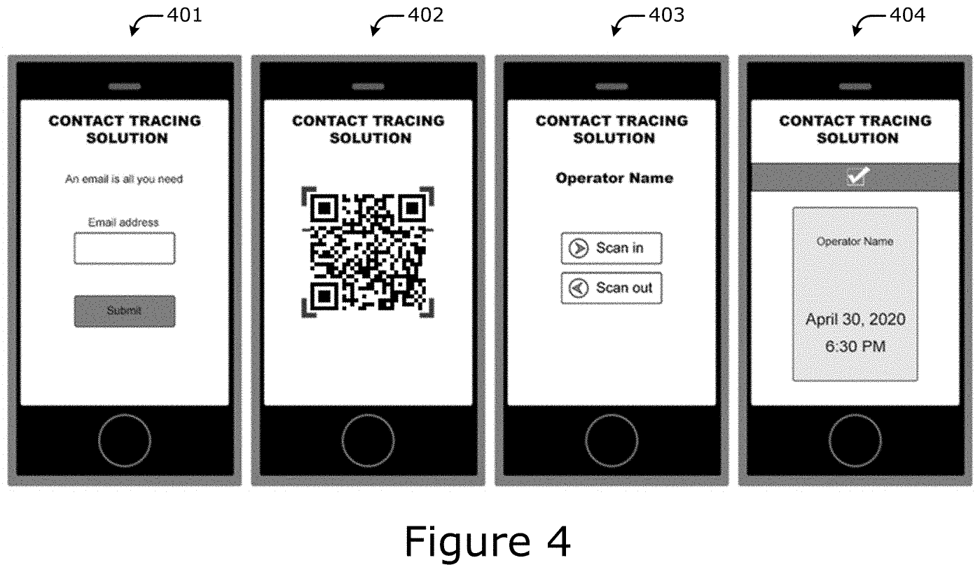

FIG. 4 illustrates example graphical user interfaces (GUIs) facilitated by a remote system (e.g., CTS 150 of FIG. 1) according to various techniques described herein. In particular, the example GUIs in FIG. 4 may be rendered and displayed by a client app (e.g., app 110 of FIG. 1 infra) and/or within an app container/skeleton, and displayed on a client system such as user system 105 and/or GPO system 110 of FIG. 1 or client system 105 of FIG. 1. While particular example interfaces are illustrated, other interfaces may be utilized in various other embodiments and/or implementations.

GUI instance 401 is a GUI that allows a user 105 to register with the CTS 150. GUI instance 402 is a GUI that allows a GPO 110 to scan a QR 106 provided by a user 105. GUI instance 403 is a GUI allowing the GPO 110 to indicate whether the scanned QR 106 is associated with the user 105 entering the gathering place or leaving the gathering place. GUI instance 404 is a GUI indicating successful recordation of the user's 105 QR 106 by the CTS 150.

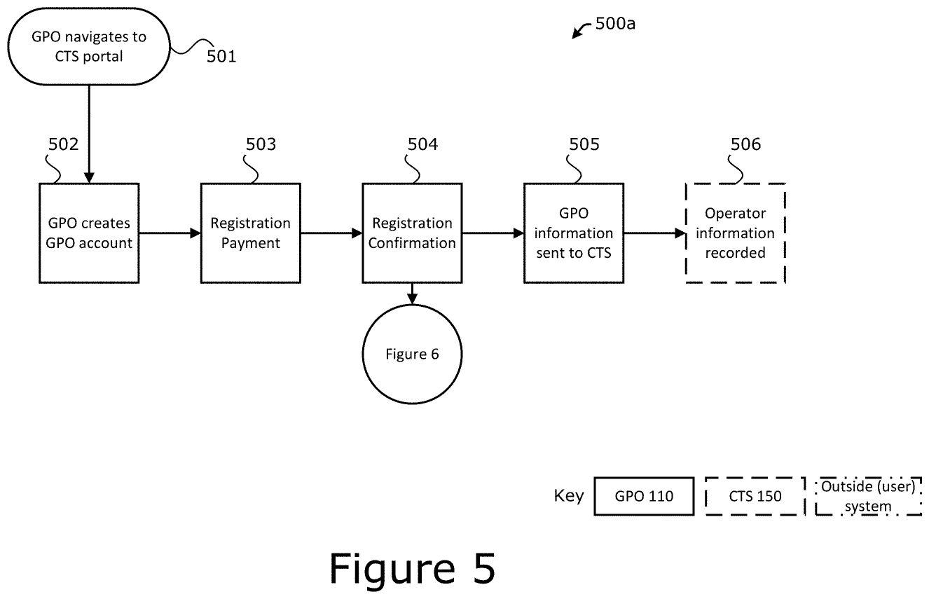

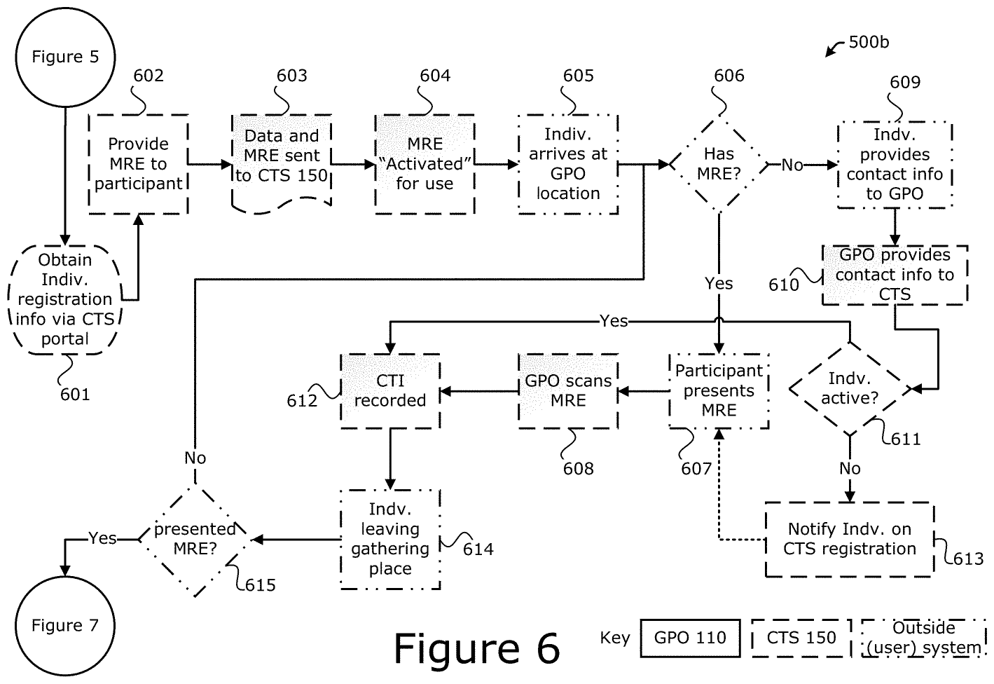

FIGS. 5-7 illustrate an example contact tracing process 500 (including processes 500a, 500b, and 500c of FIGS. 5, 6, and 7, respectively) according to various embodiments. Referring to FIG. 5, the GPO registration process 500a begins at operation 501 where a GPO 110 navigates to a CTS portal, which may be accessed through a webpage, web app, mobile app interface, or other like resource. At operation 502, the GPO 110 creates an account or profile with the CTS 150. This may include providing GPO information such as gathering place name, gathering place location (e.g., geolocation, physical address, etc.), contact name, contact phone number, contact email address, payment information, and/or other like information. The CTS portal also allows operators to login, manage/update account information (e.g., update payment information, get transaction info, add/edit contact information, etc.), view legal agreement(s), view payment statements/history, make payments, and perform other account management functions. At operation 503, the GPO 110 supplies payment information (e.g., using credit card, debit card, cryptocurrency, etc.) to pay for the registration, and a payment and registration confirmation is provided to the GPO 110 at operation 504. As examples, the payment/registration confirmation may be sent to the GPO 110 via email, SMS/MMS message, over-the-top (OTT) message, push notification to the GPO device 110, and/or the like. In one implementation, a welcome email is sent to the GPO 110 including a template that they may use to email clients/customers (e.g., individuals 105) with information on where and how to register for an MRE 106, signage that they can place on the gathering place premises, and the link/URL to where the CTS mobile app (scanner app) can be downloaded. In another implementation, this information may be accessed through the CTS portal mentioned previously. Meanwhile, at operation 505 the supplied GPO information is sent to the CTS 150 for storage in the contact tracing DBs 156. At operation 506, the GPO information is stored in the contact tracing DBs 156 by the CTS 150. The contact tracing process 500 continues at process 500b shown by FIG. 6.

FIG. 6 shows a client-side process 500b of the contact tracing process 500. Process 500b begins at operation 601 where individuals 105 register with the CTS 150 by providing/supplying contact information (e.g., email address, phone number, and/or the like) and/or other information to the CTS 150 via the CTS portal. In some implementations, the individual 105 may be required to accept or provide consent to an end-user license and/or other legal agreements (e.g., age consent, etc.). In some implementations, the participant 105 may be able to go back and opt out of the CTS 150 at any time and see a report of stored data of the gathering places they visited during the time they were enrolled with the CTS 150. After the registration process, at operation 602 the CTS 150 generates an MRE 106 for the individual 105, which is then provided to the individual 105 (e.g., in an email, SMS/MMS, OTT message, push notification, etc.). The supplied data and the MRE 106 are sent to the CTS 150 for storage in the DB 156 at operation 603, and the MRE 106 is then “Activated” for use at operation 604.

At some point after the registration process, the participant 105 may arrive at a GPO 110 gathering place at operation 605. At operation 606, if the participant 105 has an active MRE 106, the participant 105 presents the MRE 106 to be scanned by the GPO 110 and contact tracing information (CTI) is recorded at operations 607 and 608. Otherwise at operation 609, the participant 105 provides contact info (e.g., email, phone number, or the like) to the GPO 110, and at operation 611, the GPO 110 provides the contact information to the CTS 150 (e.g., by entering the email or phone number into the CTS mobile app). At operation 611, the participant 105 is determined to be active in the CTS or not 150, and the CTI is recorded if the participant 105 is an active participant 105 in the CTS 150 at operation 612.

If the participant 105 is not active in the CTS 150, the CTS 150 notifies the participant 105 on how they can register with the CTS at operation 613. For example, the CTS 150 may send the participant 105 an email or other message letting them know that they should complete registration (e.g., T/C consent) in order for the CTS 150 to log the MRE 106 scan. In some implementations, individual users 105 can register with the CTS 150 on-site at a gathering place by scanning a CTS 150-provided MRE posted at the gathering place. This MRE could be displayed on media such as a poster or signage on the gathering place (e.g., at a front door, on a restaurant menu, or the like). This MRE may be generated and/or provided to GPOs 110 in a same or similar manner as discussed previously with respect to the MRE 106. In these embodiments, scanning the CTS 150-provided MRE by the user device 105 may cause the user device 105 to execute a client app (e.g., web browser) and navigate to the CTS portal for registering with the CTS 150 as discussed previously (e.g., operations 601-606 may be performed). After registration, the individual 105 may present their MRE 106 at operation 607, which is then scanned at operation 608.

As mentioned previously, the individual's 105 CTI is recorded at operation 612. The CTI may include the gathering place name, gathering place location, a timestamp of the scan, and whether the scan was done for entry to the gathering place or exit from the gathering place. In some embodiments, the CTI may include other information such as the other types of data discussed herein. The CTI may be recorded by the CTS mobile app and provided to the CTS 150, or the contact tracing information may be forwarded to the CTS 150 by the GPO 110 device. Additionally or alternatively, in the event that a user 105 forgets to scan their MRE 106 when entering or exiting a gathering place, the CTS 150 generates a presumed or estimated timestamp for the missed scan for that individual 105 at the time of reporting. The presumed/estimated timestamp is predetermined by the gathering place (or GPO 110) as some or all gathering places may have a different duration of time that patrons spend while visiting their gathering place.

When the participant 105 leaves (or attempts to leave) the gathering place at operation 614, the participant 105 may present their MRE 106 (if they have one) at operation 615 or supplies their contact info to the GPO 110 (if they do not have an MRE 106 with them) for recordation of the CTI upon exiting the gathering location (e.g., operations 606 to 613).

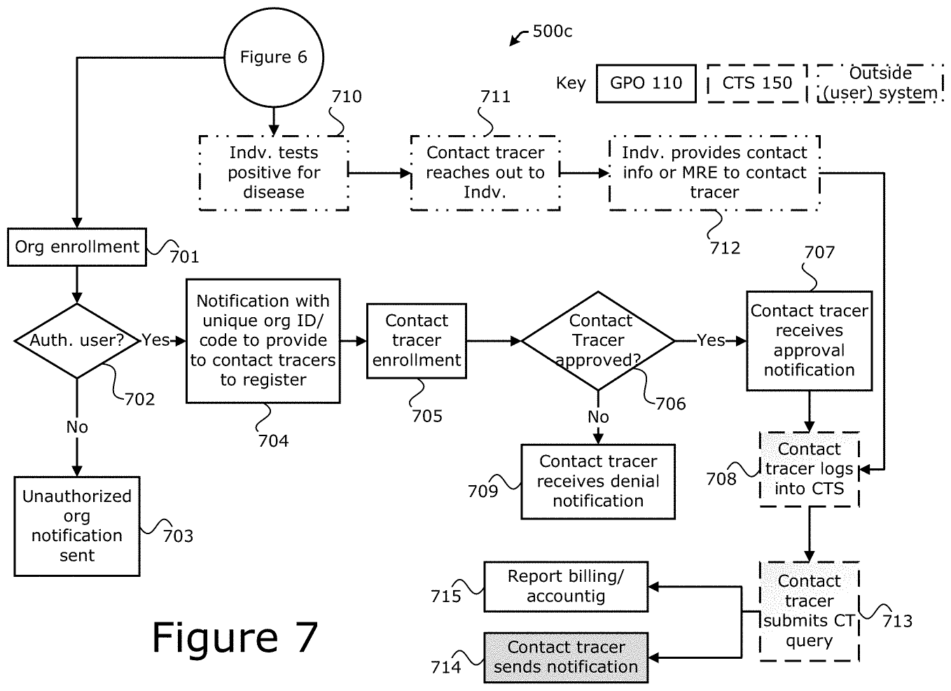

Process 500c of FIG. 7, the contact tracer organization (org) may enroll with the CTS 150 using the CTS portal at operation 701. The org typically is a public health authority, and may be a governmental agency, regulatory body, public health institution, non-governmental organization (NGO), enterprise, business, or the like. The org (or agent/employee of the org) may provide org information (e.g., org name, address, contact information (website, email, phone, etc.), payment information, etc.) and/or individual contact tracer information (e.g., name, contact information (email, phone, etc.), title, role, supervisor contact information (email, phone, etc.), payment information (e.g., credit card, etc.). The enrollment process may also include org agent agreeing to an end-user license and/or other legal agreements. The org information is then sent to the CTS 150 for storage.

After the registration process, an agent or representative of the org may attempt to login to the CTS 150. At operation 702, if the org (or org agent) is not identified as an authorized user, a suitable notification/message is sent indicating the relevant issues at operation 703. Otherwise, at operation 704 a welcome notification is provided to the org, org agent and/or contact tracer 121 (e.g., as an email or other message, or a “home” page or screen of the CTS portal). This notification (welcome message) includes a unique org ID or code that may be provided to individual contact tracers 121 for them to register and/or use the CTS 150. At operation 705, individual contact tracers 121 may use this org ID/code to enroll with the CTS 150 in a same or similar manner as discussed previously (including supplying contact tracer info as discussed previously). After the contact tracer registration, if the contact tracer 121 is approved by the CTS 150 for use of the org's contact tracing services at operation 706, the contact tracer 121 is provided with an approval message/notification at operation 707. In some implementations, this may involve sending a notification to a manager or supervisor to provide authorization for enrolling the contact tracer 121. The CTS 150 may provide the ability for managers/supervisors to turn off access and/or update contact tracer 121 changes. If the contact tracer 121 is approved by the org (manager/supervisor) at operation 706 (and after operation 707), then contact tracer 121 may log into the CTS 150 for contact tracing purposes at operation 708. If the contact tracer 121 is not approved by the org (manager/supervisor) at operation 706, then contact tracer 121 receives a denial notification (e.g., email, etc.) at operation 709 indicating the relevant issues and/or who to contact with questions. Additionally or alternatively, individual contact tracers 121 who are authorized/approved by their PHA 220 can register to receive activity reports 123 even if the PHA 220 itself is not registered. In these implementations, the individual contact tracers 121 who are authorized/approved by their PHA 220 can receive activity reports 123 even if neither the contact tracer 121 nor the PHA 220 are registered.

Meanwhile, at operation 710 if a participant 105 tests positive for a communicable disease, a contact tracer 121 reaches out to that participant 105 (and the participant may be considered a “case subject”) at operation 711. The case subject 105 provides their contact info or MRE 106 to the contact tracer 121 at operation 712, and the contact tracer 121 logs into the CTS 150 via the CTS portal at operation 708, and submits a contact tracing (CT) query at operation 713 using the provided contact info or MRE 106. The CT query may also include various query parameters, filters, conditions, etc. The CT query may be used to generate the report 123 including the gathering places that the case subject 105 visited in a predefined or requested time period, contact information for the visited gathering places, and/or other information. The CTS portal may provide the ability to run multiple reports using various search criteria, as well as provide various visual representations of the data (e.g., heat maps, charts, graphs, etc.). After the reports 123 are generated, at operation 714 the contact tracer 121 may send notifications to potential contacts of the case subject 105. Additionally, at operation 715 the CTS 150 may generate billing/accounting information for use of the system 150.

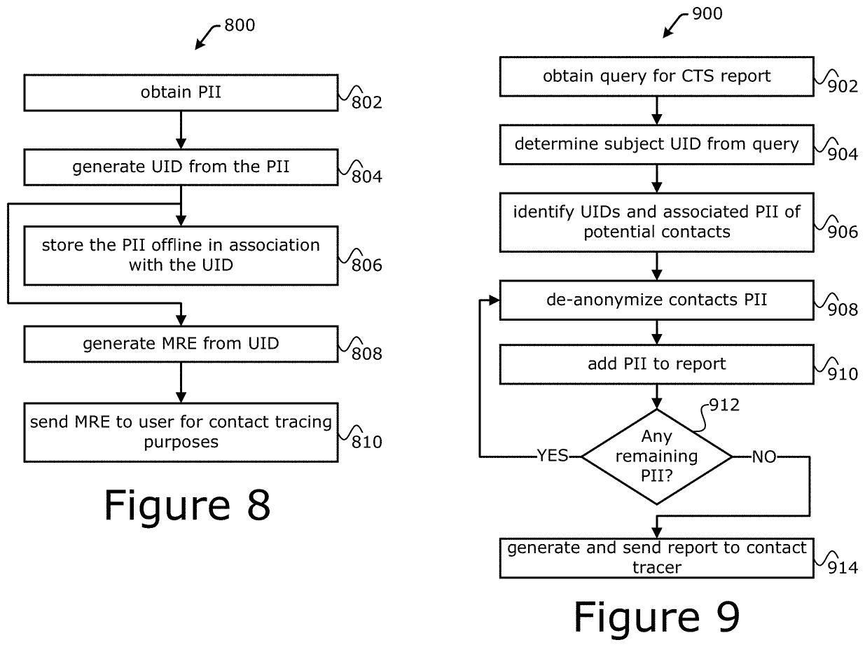

FIG. 8 depicts an example user enrollment/registration process 800 according to various embodiments. Process 800 begins at operation 802 where the CTS 150 obtains PII from a user 105. For example, as alluded to previously, a registration web/app operated by the CTS server(s) 155 may be accessed via a web/app interface of a CTS client app operated by the user system 105. This web/app interface may include form fields for the user 105 to enter contact information and/or other PII. Examples of PII that may be entered or otherwise provided by the user 105 include name, physical/mailing address, phone number, email address, medical data (e.g., lab test results, vaccination records, etc.), and/or the like. Additionally or alternatively, the web/app interface may request other information to be provided by the user 105 such as biometric data and/or the like.

Additionally or alternatively, the web/app interface may include client-side script, tags, program code, etc., that collects some PII from the user 105 when the web/app interface is accessed by the user system 105. Examples of this collected information may include a user ID (userId), client app ID, app type (e.g., browser or the like) and/or version, an app session ID, user agent string, operating system (OS) type and/or version, app and/or OS vendor, a network address (such as those discussed herein), a network session ID, a device ID or serial number, a product ID, EPC, RFID tag ID, an integer assigned to the user 105 by a Unix-like OS (e.g., effective user ID (euid), file system user ID (fsuid), saved user id (suid), real user id (ruid), etc.), a cookie ID, a realm name, domain name/ID, logon user name or credentials, network credentials, social media account name, session ID, a device fingerprint of the user system 105, a digital certificate, and/or any other like identifier associated with a particular user 105 or device 105) and/or the like.

At operation 804, the CTS 150 generates a UID using the PII obtained at operation 802. In embodiments, the UID may be generated from any combination of the PII entered or otherwise provided by the user 105 and/or the PII that was collected by the CTS web/app interface during the registration process. In one example implementation, only the user's 105 email address is used to generate the UID. In another example implementation, the user's 105 email address and one or more other PII items are used to generate the UID. In some embodiments, different combinations of PII may be used to generate the UIDs for different users 105, such as when different types of PII are available (or not) for different users. For example, only an email address may be used for generating a first user's 105 UID who only provided their email address, an email address and a user device 105 type/platform may be used to generate a second user's 105 UID when multiple types of PII were obtained by the CTS 150, and biometric data may be used to generate a third user's 105 UID when the third user 105 provides biometric data, and so forth.

In various embodiments, the UID may be generated by anonymizing or pseudonymizing the PII. Any number of data anonymization or pseudonymization techniques may be used including, for example, data encryption, substitution, shuffling, number and date variance, and nulling out specific fields or data sets. Data encryption is an anonymization or pseudonymization technique that replaces personal/sensitive/confidential data with encrypted data. Anonymization is a type of information sanitization technique that removes personal, sensitive, and/or confidential data from data or datasets so that the person or information described or indicated by the data/datasets remain anonymous. Pseudonymization is a data management and de-identification procedure by which personal, sensitive, and/or confidential data within InObs (e.g., fields and/or records, data elements, documents, etc.) is/are replaced by one or more artificial identifiers, or pseudonyms. In most pseudonymization mechanisms, a single pseudonym is provided for each replaced data item or a collection of replaced data items, which makes the data less identifiable while remaining suitable for data analysis and data processing. Although “anonymization” and “pseudonymization” refer to different concepts, these terms may be used interchangeably throughout the present disclosure. In some implementations, a suitable hash algorithm may be used as an anonymization or pseudonymization technique. For example, as discussed previously, the UID may be a hash value calculated from one or more inputs (which may or may not be unique to the individual/user system 105). In one example, the UID may be generated using the supplied contact information (or a portion thereof) as an input to a suitable hash function.

At operation 806, the CTS 150 stores the PII offline (e.g., by the DB server(s) 155b in CTS DB 156) in association with the UID. Prior to, simultaneously with, or after the PII and UID are stored, at operation 808 the CTS 150 generates the MRE 106 based on the UID. The MRE 106 may be generated as discussed previously, for example, by encoding the UID in the MRE 106 when the MRE 106 is a QR code, barcode, EPC, RFID tag, and/or the like. At operation 810, the CTS 150 sends the MRE 106 to the user system 105, which can then be used for contact tracing purposes. In embodiments, the scanning and tracking processes is done only using the UID contained in the MRE 106. In this way, if any of the systems are compromised (e.g., due to data leaks or breaches) the user's 105 PII will not be compromised. After performance of operation 810, process 800 may end or repeat as necessary.

FIG. 9 depicts an example contact tracing process 900 according to various embodiments. Process 900 may be performed by the CTS 150. Process 900 begins at operation 902 where the CTS 150 obtains a query 205 for a CTS report 123. For example, as alluded to previously, a CTS web/app operated by the CTS server(s) 155 may be accessed via a web/app interface of an admin portal 120 app operated by the admin portal 120 and/or via a CTS client app operated by the user system 105 and/or a GPO device 110. This web/app interface may include a text box and/or form fields, which allows the contact tracers 121 or users of the user system 105, GPO device 110, and/or admin portal 120 to enter and submit the query 205. For example, the contact tracers 121 or users may enter and submit the case subject's UID and/or other PII of the subject. In one implementation, the query 205 only includes the subject's UID. Additionally or alternatively, the web/app interface may enable the user system 105, GPO device 110, and/or admin portal 120 to scan the MRE 106 of a subject of the search, where the web/app interface may automatically send the MRE 106 as the query 205 (which is then extracted and processed by the CTS 150), or the web/app interface may automatically extract and submit the UID from the MRE 106 as the query 205. In either case, the UID may be pulled into a local machine or system of the CTS 150.

At operation 904, the CTS 150 determines the subject's UID from query 205. This may be done by associating the UID with a key and/or anonymized PII, such as an encrypted email address or the like. For example, the CTS DB server(s) 155b may use the UID as a key or index to search the CTS DB 156 for records corresponding to the UID. These records may include the PII of the subject of the to-be-generated CTS report 123.

At operation 906, the CTS 150 determines potential contacts of the case subject based on the case subject's entry and/or exit times stored in CTS DB server(s) 155b. Any other individual 105 that has entry and/or exit times at gathering places at or around the entry and/or exit times of the case subject at those gathering places may be identified from searching the CTS DB 156. The CTS DB server(s) 155b may obtain the UIDs and/or the PII of these potential contacts for inclusion in the CTS report 123, which may be temporarily stored using a suitable data processing and/or caching mechanism. At operation 908, the CTS 150 de-anonymizes the PII of the potential contacts by, for example, reversing the employed anonymization techniques (e.g., decrypting and/or the like). At operation 910, the CTS 150 adds the potential contact to the CTS report 123. At operation 912, the CTS 150 determines if there are any remaining potential contacts to be added to the CTS report 123, and if so, the CTS 150 loops back to perform operations 908 and 910. If there are no remaining potential contacts to be added to the CTS report 123, then the CTS 150 proceeds to operation 914 to generate and send the CTS report 123 to the requesting party (e.g., the contact tracer 121 and/or user of the user system 105, GPO device 110, and/or admin portal 120 that submitted the query 205). After performance of operation 914, process 900 may end or repeat as necessary.

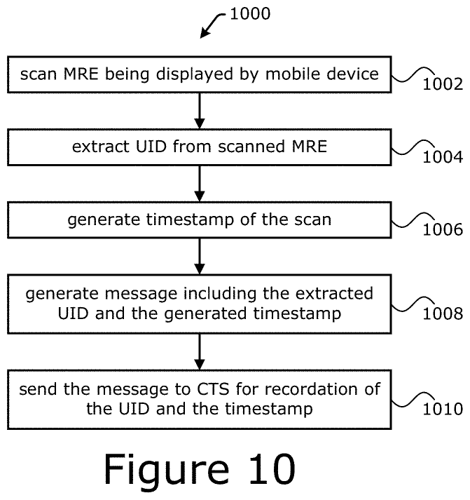

FIG. 10 depicts an example contact tracing process 1000 according to various embodiments. Process 1000 may be performed by a GPO device 110 or application operated by a GPO device 110. At operation 1002, the GPO device 110 scans a MRE 106 being displayed by another mobile device (e.g., user device 105). At operation 1004, the GPO device 110 extracts a UID from the scanned MRE. At operation 1006, the GPO device 110 generates a timestamp of a time at which the scan occurred. At operation 1008, the GPO device 110 generates a message including the UID and the timestamp for recording an entry or exit time at a particular gathering place; and at operation 1010, the GPO device 110 sends the message to a CTS system for recordation of the UID and the timestamp. After performance of operation 1010, process 1000 may end or repeat as necessary (e.g., when the user device 105 attempts to leave the gathering place, or when a different user device 105 attempts to enter or leave the gathering place).

### 2. Example Hardware and Software Systems and Configurations

Referring back to FIG. 1, the client systems used by the users 105, GPOs 110, and admin portal/terminal 120 (also referred to as a “client device,” “user system,” “user device,” or the like) include physical hardware devices and software components capable of accessing content and/or services provided by the CTS 150. In order to access the content/services, the client systems 105 include components such as processors, memory devices, communication interfaces, and the like. Additionally, the client system 105 may include, or be communicatively coupled with, one or more sensors (e.g., image capture device(s), microphones, etc.), which is/are used to capture biometric data. As discussed in more detail infra, the captured biometric data is then provided to the CTS 150 for contact tracing purposes. The client systems 105 communicate with the CTS 150 to obtain content/services using, for example, Hypertext Transfer Protocol (HTTP) over Transmission Control Protocol (TCP)/Internet Protocol (IP), or one or more other common Internet protocols such as File Transfer Protocol (FTP); Session Initiation Protocol (SIP) with Session Description Protocol (SDP), Real-time Transport Protocol (RTP), Secure RTP (SRTP), and/or Real-time Streaming Protocol (RTSP); Real-Time Communication (RTC) and/or WebRTC; Secure Shell (SSH); Extensible Messaging and Presence Protocol (XMPP); WebSocket; and/or some other communication technology such as those discussed herein. In this regard, the client system 105 may establish a communication session with the CTS 150. As used herein, a “session” refers to a persistent interaction between a subscriber (e.g., client system 105A) and an endpoint that may be either a relying party (RP) such as a web server, app server, or a Credential Service Provider (CSP) such as CTS 150. A session begins with an authentication event and ends with a session termination event. A session is bound by use of a session secret (e.g., a password, digital certificate, etc.) that the subscriber's software (a browser, app, or OS) can present to the RP or CSP in lieu of the subscriber's authentication credentials. A “session secret” refers to a secret used in authentication that is known to a subscriber and a verifier. The client systems can be implemented as any suitable computing system or other data processing apparatus usable by users to access content/services provided by the CTS 150. In the example of FIG. 1, some of the client systems are depicted as mobile cellular phones (e.g., a “smartphones”), tablet computers, and desktop computers or workstations (e.g., admin portal 120); however, the client systems can be any other suitable computer system such as laptop computers, tablet computers, portable media players, wearable computing devices (e.g., smart watches and/or the like), or some other computing systems/devices.

In some examples, the CTS 150 may represent a cloud computing service, an intranet, enterprise network, or some other like private network that is unavailable to the public. In one example implementation, the entirety of CTS 150 including both the front end and the back end may be implemented in or by a cloud computing service (e.g., a “full stack” cloud implementation). The cloud computing service (or “cloud”) includes networks of physical and/or virtual computer systems (e.g., one or more servers), data storage systems/devices, etc. within or associated with a data center or data warehouse that provide access to a pool of computing resources. The one or more servers in a cloud include user computer systems, where each of the servers includes one or more processors, one or more memory devices, input/output (I/O) interfaces, communications interfaces, and/or other like components. The servers may be connected with one another via a Local Area Network (LAN), fast LAN, message passing interface (MPI) implementations, and/or any other suitable networking technology. Various combinations of the servers may implement different cloud elements or nodes, such as cloud manager(s), cluster manager(s), master node(s), one or more secondary (slave) nodes, and the like. The one or more servers may implement additional or alternative nodes/elements in other embodiments. In some cloud implementations, at least some of the servers in the cloud (e.g., servers that act as secondary nodes) may implement app server and/or web server functionality, which includes, inter alia, obtaining various messages from the client systems; processing data contained in those messages; routing data to other nodes in the cloud for further processing, storage, retrieval, etc.; generating and communicating messages including data items, content items, program code, renderable webpages and/or documents (e.g., including the various GUIs discussed herein), and/or other information to/from client systems; and/or other like app server functions. In this way, various combinations of the servers may implement different cloud elements/nodes configured to perform the embodiments discussed herein.

The CTS 150 includes one or more CTS servers 155 and a CTS database (DB) 156. The web server(s) 155a serve static content from a file system of the web server(s). The CTS servers 155 may be virtual or physical systems that provide contact tracing services to individual users (e.g., using a client system(s)) and/or for customer platforms. In some embodiments, some or all of the contact tracing services may be provided by or accessed from third party systems/services, and in some of these embodiments, the information provided by the third party systems/services may be enhanced or amended using information collected by the CTS 150. The virtual and/or physical systems may include app servers, web servers, and/or other like computing systems/devices. The particular contact tracing services provided by the CTS servers 155 may depend on the architecture or implementation of the CTS 150, and may vary from embodiment to embodiment. In one example, one or more of the CTS server 155 may operate as an app server and may provide a respective contact tracing service (e.g., registration, UID and/or MRE 106 generation, report 123 generation, etc.) as separate processes, or by implementing autonomous software agents. In another example, individual CTS servers 155 may be dedicated to perform separate contact tracing services, and app servers may be used to obtain requests from client systems 105 and provide information/data to the CTS servers 145 to perform their respective contact tracing services. Examples of the contact tracing services are discussed in more detail infra.

The web/app servers 155a comprise one or more physical and/or virtualized systems for providing content and/or functionality (e.g., services) to one or more clients (e.g., client system) over a network. The physical and/or virtualized systems include one or more logically or physically connected servers and/or data storage devices distributed locally or across one or more geographic locations. Generally, the web/app servers 155a are configured to use IP/network resources to provide web pages, forms, apps, data, services, and/or media content to client system. Additionally or alternatively, the web/app servers 155a may generate and serve dynamic content (e.g., server-side programming, database connections, dynamic generation of web documents) using an appropriate plug-in (e.g., a ASP.NET plug-in). The app server(s) implement an app platform, which is a framework that provides for the development and execution of server-side apps as part of an app hosting service. The app platform enables the creation, management, and execution of one or more server-side apps developed by the CTS 150 and/or third-party app developers, which allow users and/or third-party app developers to access the CTS 150 via respective client systems. The client systems may operate respective client apps to access the dynamic content, for example, by sending appropriate HTTP messages or the like, and in response, the server-side app(s) may dynamically generate and provide source code documents to the client app, and the source code documents are used for generating and rendering graphical objects (or simply “objects”) within the client app. The server-side apps may be developed with any suitable server-side programming languages or technologies, such as PHP; Java™ based technologies such as Java Servlets, JavaServer Pages (JSP), JavaServer Faces (JSF), etc.; ASP.NET; Ruby or Ruby on Rails; and/or any other like technology that renders HyperText Markup Language (HTML), such as those discussed herein. The apps may be built using a platform-specific and/or proprietary development tool, and/or programming languages.

The CTS servers 155 serve one or more instructions or source code documents to client systems, which may then be executed within a client app 110 to render one or more objects (e.g., graphical user interfaces (GUIs)). The GUIs comprise graphical control elements (GCEs) that allow the client systems to perform various functions and/or to request or instruct the CTS 150 to perform various functions. The CTS servers 155 may provide various interfaces such as those discussed herein. The interfaces may be developed using website development tools and/or programming languages (e.g., HTML, Cascading Stylesheets (CSS), JavaScript, Jscript, Ruby, Python, etc.) and/or using platform-specific development tools (e.g., Android® Studio™ integrated development environment (IDE), Microsoft® Visual Studio® IDE, Apple® iOS® software development kit (SDK), Nvidia® Compute Unified Device Architecture (CUDA)® Toolkit, etc.). The term “platform-specific” may refer to the platform implemented by the client systems and/or the platform implemented by the CTS servers 155. Example interfaces are shown and described with regard to FIGS. 1-7. In an example implementation, the servers 155 may implement Apache HTTP Server (“httpd”) web servers or NGINX™ webservers on top of the Linux® OS. In this example implementation, PHP and/or Python may be employed as server-side languages, MySQL may be used as the DQL/DBMS. In an example implementation, the mobile apps may be developed for Android®, iOS®, and/or some other mobile platform.

In some embodiments, the one or more CTS servers 155 may implement or operate user artificial intelligence (AI) agents to perform respective identity verification services of the identity verification services discussed previously, or portions thereof. The AI agents are autonomous entities configured to observe environmental conditions and determine actions to be taken in furtherance of a particular goal and based on learnt experience (e.g., empirical data). The particular environmental conditions to be observed, the actions to be taken, and the particular goals to be achieved may be based on an operational design domain (ODD) and/or may be specific or based on the subsystem itself. An ODD includes the operating conditions under which a given AI agent, or feature thereof, is specifically designed to function. An ODD may include operational restrictions, such as environmental, geographical, and time-of-day restrictions, and/or the requisite presence or absence of certain conditions or characteristics.

To observe environmental conditions, the AI agent(s) is/are configured to receive, or monitor for, collected data from client systems, CTS servers 155, CTS 150, and/or other sources. The act of monitoring may include, for example, polling (e.g., periodic polling, sequential (roll call) polling, etc.) client systems and/or other CTS servers 155 for identity/biometric data for a specified/selected period of time. In other embodiments, monitoring may include sending a request or command for identity/biometric data in response to an external request for identity/biometric data. In some embodiments, monitoring may include waiting for identity/biometric data from various client systems based on triggers or events. The events/triggers may be AI agent specific and may vary depending on a particular embodiment. In some embodiments, the monitoring may be triggered or activated by an app or subsystem of the CTS 150 and/or by a remote device, such as or server(s) of CTS 150.

To determine actions to be taken in furtherance of a particular goal, each of the AI agents are configured to identify a current state (context) of a live interview session or instance and/or the AI agent itself, identify or obtain one or more models (e.g., the various models discussed previously with respect to the example identity verification services), identify or obtain goal information, and predict a result of taking one or more actions based on the current state (context), the one or more models, and the goal information. The one or more models may be any algorithms or objects created after an AI agent is trained with one or more training datasets, and the one or more models may indicate the possible actions that may be taken based on the current state (context). The one or more models may be based on the ODD defined for a particular AI agent. The current state (context) is a configuration or set of information collected by the CTS 150 and/or one or more CTS servers 155. The current state (context) is stored inside an AI agent and is maintained in a suitable data structure. The AI agents are configured to predict possible outcomes as a result of taking certain actions defined by the models.

The goal information describes outcomes (or goal states) that are desirable given the current state (context). Each of the AI agents may select an outcome from among the predicted possible outcomes that reaches a particular goal state, and provide signals or commands to various other subsystems of the CTS 150 to perform one or more actions determined to lead to the selected outcome. In addition, the AI agents may also include a learning module configured to learn from an experience with respect to the selected outcome and some performance measure(s). The experience may include state (context) data collected after performance of the one or more actions of the selected outcome. The learned/learnt experience may be used to produce new or updated models for determining future actions to take.

The AI agent(s) is/are implemented as autonomous software agents, implemented using user hardware elements, or a combination thereof. In an example software-based implementation, the AI agents may be developed using a suitable programming language, development tools/environments, etc., which are executed by one or more processors of one or more CTS servers 155. In this example, program code of the AI agents may be executed by a single processor or by user processing devices. In an example hardware-based implementation, each AI agent may be implemented in a respective hardware accelerator (e.g., FPGA, ASIC, DSP, etc.) that are configured with appropriate bit stream(s) or logic blocks to perform their respective functions. The aforementioned processor(s) and/or hardware accelerators may be specifically tailored for operating AI agents and/or for ML functionality, such as computer vision (CV) and/or deep learning (DL) accelerators, a cluster of AI GPUs, tensor processing units (TPUs) developed by Google® Inc., Real AI Processors (RAPs™) provided by AlphaICs®, Nervana™ Neural Network Processors (NNPs) provided by Intel® Corp., Intel® Movidius™ Myriad™ X Vision Processing Unit (VPU), NVIDIA® PX™ based GPUs, the NM500 chip provided by General Vision®, Hardware 3 provided by Tesla®, Inc., an Epiphany™ based processor provided by Adapteva®, or the like. In some embodiments, the hardware accelerator may be implemented as an AI accelerating co-processor, such as the Hexagon 685 DSP provided by Qualcomm®, the PowerVR 2NX Neural Net Accelerator (NNA) provided by Imagination Technologies Limited®, the Neural Engine core within the Apple® A11 or A12 Bionic SoC, the Neural Processing Unit within the HiSilicon Kirin 970 provided by Huawei®, and/or the like.

Furthermore, one or more CTS servers 155 may hash, digitally sign, and/or encrypt/decrypt data using, for example, a cryptographic hash algorithm, such as a function in the Secure Hash Algorithm (SHA) 2 set of cryptographic hash algorithms (e.g., SHA-226, SHA-256, SHA-512, etc.), SHA 3, and so forth, or any type of keyed or unkeyed cryptographic hash function and/or any other function discussed herein; an elliptic curve cryptographic (ECC) algorithm, Elliptic Curve cryptography Digital Signature Algorithm (ECDSA), Rivest-Shamir-Adleman (RSA) cryptography, Merkle signature scheme, advanced encryption system (AES) algorithm, a triple data encryption algorithm (3DES), and/or the like.

The CTS DB 156 may be stored in one or more data storage devices or storage systems that act as a repository for persistently storing and managing collections of data according to one or more predefined DB structures. The data storage devices/systems may include one or more primary storage devices, secondary storage devices, tertiary storage devices, non-linear storage devices, and/or other like data storage devices. In some implementations, at least some of the CTS servers 155 may implement a suitable database management system (DBMS) to execute storage and retrieval of information against various database object(s) in the CTS DB 156. These CTS servers 155 may be storage servers, file servers, or other like computing systems. The DBMS may include a relational database management system (RDBMS), an object database management system (ODBMS), a non-relational DBMS (e.g., a NoSQL DB system), and/or some other DBMS used to create and maintain the CTS DB 156. The CTS DB 156 can be implemented as part of a single database, a distributed database, a collection of distributed databases, a database with redundant online or offline backups or other redundancies, etc., and can include a distributed database or storage network. These CTS server(s) 155 may implement one or more query engines that utilize one or more data query languages (DQLs) to store and retrieve information in/from the CTS DB 156, such as Structured Query Language (SQL), Structured Object Query Language (SOQL), Procedural Language/SOQL (PL/SOQL), GraphQL, Hyper Text SQL (HTSQL), Query By Example (QBE), object query language (OQL), object constraint language (OCL), non-first normal form query language (N1QL), XQuery, and/or any other DQL or combinations thereof. The query engine(s) may include any suitable query engine technology or combinations thereof including, for example, direct (e.g., SQL) execution engines (e.g., Presto SQL query engine, MySQL engine, SOQL execution engine, Apache® Phoenix® engine, etc.), a key-value datastore or NoSQL DB engines (e.g., DynamoDB® provided by Amazon.com®, MongoDB query framework provided by MongoDB Inc.®, Apache® Cassandra, Redis™ provided by Redis Labs®, etc.), MapReduce query engines (e.g., Apache® Hive™, Apache® Impala™ Apache® HAWQ™, IBM® Db2 Big SQL®, etc. for Apache® Hadoop® DB systems, etc.), relational DB (or “NewSQL”) engines (e.g., InnoDB™ or MySQL Cluster™ developed by Oracle®, MyRocks™ developed by Facebook.com®, FaunaDB provided by Fauna Inc.), PostgreSQL DB engines (e.g., MicroKernel DB Engine and Relational DB Engine provided by Pervasive Software®), graph processing engines (e.g., GraphX of an Apache® Spark® engine, an Apache® Tez engine, Neo4j provided by Neo4j, Inc.™, etc.), pull (iteration pattern) query engines, push (visitor pattern) query engines, transactional DB engines, extensible query execution engines, package query language (PaQL) execution engines, LegoBase query execution engines, and/or some other query engine used to query some other type of DB system (such as any processing engine or execution technology discussed herein). In some implementations, the query engine(s) may include or implement an in-memory caching system and/or an in-memory caching engine (e.g., memcached, Redis, etc.) to store frequently accessed data items in a main memory of the CTS server(s) 155 for later retrieval without additional access to the persistent data store. Suitable implementations for the database systems and storage devices are known or commercially available, and are readily implemented by persons having ordinary skill in the art.

The CTS DB 156 stores a plurality of database objects (DBOs). The DBOs may be arranged in a set of logical tables containing data fitted into predefined or customizable categories, and/or the DBOs may be arranged in a set of blockchains or ledgers wherein each block (or DBO) in the blockchain is linked to a previous block. Each of the DBOs may include data associated with user users, such as contact info of the user 105, entry time at a particular gathering place, exit time when leaving a gathering place, a UID, and/or, in certain embodiments, other data such as biographic data; biometric data; data collected from various external sources; identity session identifiers (IDs); and/or other like data. Additionally or alternatively, the CTS DB 156 may store vaccination-related data, which may be used to exclude individuals from CTS reports 123 when the vaccination data indicates that those individuals have been vaccinated prior to contact with a potentially infected individual. As examples, the vaccination data for a particular individual may include whether the individual has been vaccinated (e.g., stored as a Boolean value such a true or false), the type of vaccine administered to the individual, vaccine manufacturer, dates of vaccination, whether multiple doses are required for the vaccine, number of doses required for the vaccine, whether the individual followed through on a second or any other follow-up vaccination doses (if necessary), whether any booster shots were administered, location(s) where vaccine (or individual doses) are administered, personnel who administered the vaccination (or individual doses), and/or the like. In some implementations, the CTS DB server(s) 155b may periodically (e.g., after 60 days) delete MRE 106 scan activity information and/or other user PII from the CTS DB 156 unless a GPO 110 or PHA 220 requests a different period or no period at all.

Some of the DBOs may store information pertaining to relationships between any of the data items discussed herein. Some of the DBOs may store permission or access-related information for each user. These DBOs may indicate specific third parties that are permitted to access identity data of a particular user. In some implementations, the permission or access-related DBOs for each user may be arranged or stored as a blockchain to control which third parties can access that user's identity data. In these embodiments, the blockchain(s) do not actually store user biometric and/or biographic data, but instead are used to authorize specific third party platforms to access specific identity data items and to track or account for the accesses to the identity data items.

As alluded to previously, the client system(s) is/are configured to run, execute, or otherwise operate the client app. The client app is a software app designed to generate and render objects, which include various types of content. At least some of the objects include graphical user interfaces (GUIs) and/or graphical control elements (GCEs) that enable interactions with the CTS 150. In some embodiments, the client app is an app container/skeleton 110 in which a CTS app operates. For example, the objects may represent a web app that runs inside the client app, and the client app may be an HTTP client, such as a “web browser” (or simply a “browser”) for sending and receiving HTTP messages to and from a web/app servers 155a of the CTS 150. In some examples, a CTS browser extension or plug-in may be configured to allow the client app to render objects that allow the user to interact with the CTS 150 for contact tracing services according to the embodiments discussed herein. Example browsers include WebKit-based browsers, Microsoft's Internet Explorer browser, Microsoft's Edge browser, Apple's Safari, Google's Chrome, Opera's browser, Mozilla's Firefox browser, and/or the like. In some embodiments, the client app is an app specifically developed or tailored to interact with the CTS 150. For example, the client app may be a desktop or native (mobile) app that runs directly on the client system(s) without a browser, and which communicates (sends and receives) suitable messages with the CTS 150. In some embodiments, the client app is an app specifically developed or tailored to interact with the CTS 150 for contact tracing services.

The client app may be developed using any suitable programming languages and/or development tools, such as those discussed herein or others known in the art. The client app may be platform-specific, such as when the client system(s) is/are implemented as a mobile device, such as a smartphone, tablet computer, or the like. In these embodiments, the client app may be a mobile web browser, a native app (or “mobile app”) specifically tailored to operate on the mobile client system(s), or a hybrid app wherein objects (or a web app) is embedded inside the native app. In some implementations, the client app and/or the web apps that run inside the client app is/are specifically designed to interact with server-side apps implemented by the app platform of the provider system (discussed infra). In some implementations, the client app, and/or the web apps that run inside the client app may be platform-specific or developed to operate on a particular type of client system(s) or a particular (hardware and/or software) client system(s) configuration. The term “platform-specific” may refer to the platform implemented by the client system(s), the platform implemented by the CTS 150, and/or a platform of a third-party system/platform.

In the aforementioned embodiments, the client system(s) implementing a client (CTS) app is capable of controlling its communications/network interface(s) to send and receive HTTP messages to/from the CTS 150, render the objects in the client app, request connections with other devices, and/or perform (or request performance) of other like functions. The header of these HTTP messages includes various operating parameters and the body of the HTTP messages include program code or source code documents (e.g., HTML, XML, JSON, and/or some other like object(s)/document(s)) to be executed and rendered in the client app. The client app executes the program code or source code documents and renders the objects (or web apps) inside the client app.

The rendered objects (or executed web app) allows the user of the client system(s) to view content provided by the CTS 150, which may include the results of a requested service, visual representations of data, hyperlinks or links to other resources, and/or the like. The rendered objects also include interfaces for interacting with the CTS 150, for example, to request additional content or services from the CTS 150. In an example, the rendered objects may include GUIs, which are used to manage the interactions between the user of the client system(s) and the CTS 150. The GUIs comprise one or more GCEs (or widgets) such as buttons, sliders, text boxes, tabs, dashboards, etc. The user of the client system(s) may select or otherwise interact with one or more of the GCEs (e.g., by pointing and clicking using a mouse, or performing a gesture for touchscreen-based systems) to request content or services from the CTS 150.

In some cases, the user of client system(s) may be required to authenticate their identity in order to obtain content and/or services from the CTS 150, and the CTS 150 provides contact tracing services for the user of client system(s) so that the user can access the content/services from the CTS 150. To provide the contact tracing services to the user, the client app may be, or may include, a secure portal to the CTS 150. The secure portal may be a stand-alone app, embedded within a web or mobile app provided by CTS 150, and/or invoked or called by the web/mobile app provided by CTS 150 (e.g., using an API, Remote Procedure Call (RPC), and/or the like). In these cases, graphical objects rendered and displayed within the client app may be a GUI and/or GCEs of the secure portal, which allows the user to share data (e.g., contact info, biographic data, biometric data, etc.) with the CTS 150. In any of the aforementioned embodiments and example use cases, the secure portal allows users 105, GPOs 110, and/or orgs/contact tracers 121 to enroll with the CTS 150 for contact tracing purposes. The secure portal also allows enrolled users to access and/or perform various contact tracing tasks. For example, the secure portal may provide access to a dashboard GUI that allows contact tracers 121 to submit queries for case subjects (e.g., contact information); obtain/see the depth and quality of contact data for a particular case subject, update and improve the quality of the collected information, and set notifications for automatically receiving updated data for contacts of particular case subjects.

Additionally or alternatively, the client app may collect various data from the client system(s) without direct user interaction with the client app. For example, the client app may cause the client system(s) to generate and transmit one or more HTTP messages with a header portion including, inter alia, an IP address of the client system(s) in an X-Forwarded-For (XFF) field, a time and date that the message was sent in a Date field, and/or a user agent string contained in a User Agent field. The user agent string may indicate an operating system (OS) type/version being operated by the client system(s), system information of the client system(s), an app version/type or browser version/type of the client app, a rendering engine version/type implemented by the client app, a device and/or platform type of the client system(s), and/or other like information. These HTTP messages may be sent in response to user interactions with the client app (e.g., when a user submits biographic or biometric data as discussed infra), or the client app may include one or more scripts, which when executed by the client system(s), cause the client system(s) to generate and send the HTTP messages upon loading or rendering the client app. Other message types may be used and/or the user and/or client system(s) information may be obtained by other means in other embodiments.

In addition to (or alternative to) obtaining information from HTTP messages as discussed previously, the CTS servers 155 may determine or derive other types of user information associated with the client system(s). For example, the CTS servers 155 may derive a time zone and/or geolocation in which the client system(s) is/are located from an obtained IP address. In some embodiments, the user and/or client system(s) information may be sent to the CTS servers 155 when the client system(s) loads or renders the client app. For example, the login page may include JavaScript or other like code that obtains and sends back information (e.g., in an additional HTTP message) that is not typically included in an HTTP header, such as time zone information, global navigation satellite system (GNSS) and/or Global Positioning System (GPS) coordinates, screen or display resolution of the client system(s), and/or other like information. Other methods may be used to obtain or derive such information in other embodiments.

FIG. 11 illustrates an example of a computing system 1100 (also referred to as “platform 1100,” “device 1100,” “appliance 1100,” or the like) in accordance with various embodiments. In FIG. 11, like numbered items are the same as discussed previously with respect to FIGS. 1-7. The system 1100 may be suitable for use as any of the computer devices discussed herein, such as the client systems 105, CTS servers 155, and the like. The components of system 1100 may be implemented as an individual computer system, or as components otherwise incorporated within a chassis of a larger system. The components of system 1100 may be implemented as integrated circuits (ICs) or other discrete electronic devices, with the appropriate logic, software, firmware, or a combination thereof, adapted in the computer system 1100. Additionally or alternatively, some of the components of system 1100 may be combined and implemented as a suitable SoC, SiP, MCP, and/or the like.

The system 1100 includes physical hardware devices and software components capable of providing and/or accessing content and/or services to/from the remote system 1155. The system 1100 and/or the remote system 1155 can be implemented as any suitable computing system or other data processing apparatus usable to access and/or provide content/services from/to one another. As examples, the system 1100 and/or the remote system 1155 may comprise desktop computers, a work stations, laptop computers, mobile cellular phones (e.g., “smartphones”), tablet computers, portable media players, wearable computing devices, server computer systems, an aggregation of computing resources (e.g., in a cloud-based environment), or some other computing devices capable of interfacing directly or indirectly with network 1150 or other network. The system 1100 communicates with remote systems 1155, and vice versa, to obtain/serve content/services using any suitable communication protocol, such as any of those discussed herein.

Referring now to system 1100, the system 1100 includes processor circuitry 1102, which is configured to execute program code, and/or sequentially and automatically carry out a sequence of arithmetic or logical operations; and record, store, and/or transfer digital data. The processor circuitry 1102 includes circuitry such as, but not limited to, one or more processor cores and one or more of cache memory, low drop-out voltage regulators (LDOs), interrupt controllers, serial interfaces such as serial peripheral interface (SPI), inter-integrated circuit (I²C) or universal programmable serial interface circuit, real time clock, timer-counters including interval and watchdog timers, general purpose input/output (I/O), memory card controllers, interconnect (IX) controllers and/or interfaces, universal serial bus (USB) interfaces, mobile industry processor interface (MIPI) interfaces, Joint Test Access Group (JTAG) test access ports, and the like. The processor circuitry 1102 may include on-chip memory circuitry or cache memory circuitry, which may include any suitable volatile and/or non-volatile memory, such as DRAM, SRAM, EPROM, EEPROM, Flash memory, solid-state memory, and/or any other type of memory device technology, such as those discussed herein. Individual processors (or individual processor cores) of the processor circuitry 1102 may be coupled with or may include memory/storage and may be configured to execute instructions stored in the memory/storage to enable various apps or operating systems to run on the system 1100. In these embodiments, the processors (or cores) of the processor circuitry 1102 are configured to operate app software (e.g., logic/modules 1183) to provide specific services to a user of the system 1100. In some embodiments, the processor circuitry 1102 may include a special-purpose processor/controller to operate according to the various embodiments herein.

In various implementations, the processor(s) of processor circuitry 1102 may include, for example, one or more processor cores (CPUs), graphics processing units (GPUs), reduced instruction set computing (RISC) processors, Acorn RISC Machine (ARM) processors, complex instruction set computing (CISC) processors, digital signal processors (DSP), programmable logic devices (PLDs), field-programmable gate arrays (FPGAs), Application Specific Integrated Circuits (ASICs), SoCs and/or programmable SoCs, microprocessors or controllers, or any suitable combination thereof. As examples, the processor circuitry 1102 may include Intel® Core™ based processor(s), MCU-class processor(s), Xeon® processor(s); Advanced Micro Devices (AMD) Zen® Core Architecture processor(s), such as Ryzen® or Epyc® processor(s), Accelerated Processing Units (APUs), MxGPUs, or the like; A, S, W, and T series processor(s) from Apple® Inc., Snapdragon™ or Centriq™ processor(s) from Qualcomm® Technologies, Inc., Texas Instruments, Inc.® Open Multimedia Applications Platform (OMAP)™ processor(s); Power Architecture processor(s) provided by the OpenPOWER® Foundation and/or IBM®, MIPS Warrior M-class, Warrior I-class, and Warrior P-class processor(s) provided by MIPS Technologies, Inc.; ARM Cortex-A, Cortex-R, and Cortex-M family of processor(s) as licensed from ARM Holdings, Ltd.; the ThunderX2® provided by Cavium™, Inc.; GeForce®, Tegra®, Titan X®, Tesla®, Shield®, and/or other like GPUs provided by Nvidia®; or the like. Other examples of the processor circuitry 1102 may be mentioned elsewhere in the present disclosure.

In some implementations, the processor circuitry 1102 may include one or more hardware accelerators (e.g., where the system 1100 is a server computer system). The hardware accelerators may be microprocessors, configurable hardware (e.g., FPGAs, programmable ASICs, programmable SoCs, DSPs, etc.), or some other suitable special-purpose processing device tailored to perform one or more specific tasks or workloads, for example, specific tasks or workloads of the subsystems of the CTS 150, which may be more efficient than using general-purpose processor cores. In some embodiments, the specific tasks or workloads may be offloaded from one or more processors of the processor circuitry 1102. In these implementations, the circuitry of processor circuitry 1102 may comprise logic blocks or logic fabric including some other interconnected resources that may be programmed to perform various functions, such as the procedures, methods, functions, etc. of the various embodiments discussed herein. Additionally, the processor circuitry 1102 may include memory cells (e.g., EPROM, EEPROM, flash memory, static memory (e.g., SRAM, anti-fuses, etc.) used to store logic blocks, logic fabric, data, etc., in look-up tables (LUTs) and the like. In some hardware-based implementations, one or more of the subsystems of the CTS 150 may be operated by the respective AI accelerating co-processor(s), AI GPUs, TPUs, or hardware accelerators (e.g., FPGAs, ASICs, DSPs, SoCs, etc.), etc. that are configured with appropriate logic blocks, bit stream(s), etc. to perform their respective functions.

In some implementations, the processor circuitry 1102 may include hardware elements specifically tailored for AI, ML, and/or deep learning functionality, such as for operating the subsystems of the CTS 150 discussed previously with regard to FIGS. 1-7. In these implementations, the processor circuitry 1102 may be, or may include, an AI engine chip that can run many different kinds of AI instruction sets once loaded with the appropriate weightings and training code. Additionally or alternatively, the processor circuitry 1102 may be, or may include, AI accelerator(s), which may be one or more of the aforementioned hardware accelerators designed for hardware acceleration of AI apps, such as one or more of the subsystems of CTS 150. As examples, these processor(s) or accelerators may be a cluster of artificial intelligence (AI) GPUs, tensor processing units (TPUs) developed by Google® Inc., Real AI Processors (RAPs™) provided by AlphalCs®, Nervana™ Neural Network Processors (NNPs) provided by Intel® Corp., Intel® Movidius™ Myriad™ X Vision Processing Unit (VPU), NVIDIA® PX™ based GPUs, the NM500 chip provided by General Vision®, Hardware 3 provided by Tesla®, Inc., an Epiphany™ based processor provided by Adapteva®, or the like. In some embodiments, the processor circuitry 1102 and/or hardware accelerator circuitry may be implemented as AI accelerating co-processor(s), such as the Hexagon 685 DSP provided by Qualcomm®, the PowerVR 2NX Neural Net Accelerator (NNA) provided by Imagination Technologies Limited®, the Neural Engine core within the Apple® A11 or A12 Bionic SoC, the Neural Processing Unit (NPU) within the HiSilicon Kirin 970 provided by Huawei®, and/or the like.

In some implementations, the processor(s) of processor circuitry 1102 may be, or may include, one or more custom-designed silicon cores specifically designed to operate corresponding subsystems of the CTS 150. These cores may be designed as synthesizable cores comprising hardware description language logic (e.g., register transfer logic, verilog, Very High Speed Integrated Circuit hardware description language (VHDL), etc.); netlist cores comprising gate-level description of electronic components and connections and/or process-specific very-large-scale integration (VLSI) layout; and/or analog or digital logic in transistor-layout format. In these implementations, one or more of the subsystems of the CTS 150 may be operated, at least in part, on custom-designed silicon core(s). These “hardware-ized” subsystems may be integrated into a larger chipset but may be more efficient than using general purpose processor cores.

The system memory circuitry 1104 comprises any number of memory devices arranged to provide primary storage from which the processor circuitry 1102 continuously reads instructions 1182 stored therein for execution. In some embodiments, the memory circuitry 1104 is on-die memory or registers associated with the processor circuitry 1102. As examples, the memory circuitry 1104 may include volatile memory such as random access memory (RAM), dynamic RAM (DRAM), synchronous DRAM (SDRAM), etc. The memory circuitry 1104 may also include nonvolatile memory (NVM) such as high-speed electrically erasable memory (commonly referred to as “flash memory”), phase change RAM (PRAM), resistive memory such as magnetoresistive random access memory (MRAM), etc. The memory circuitry 1104 may also comprise persistent storage devices, which may be temporal and/or persistent storage of any type, including, but not limited to, non-volatile memory, optical, magnetic, and/or solid-state mass storage, and so forth.

Storage circuitry 1108 is arranged to provide persistent storage of information such as data, apps, operating systems (OS), and so forth. As examples, the storage circuitry 1108 may be implemented as hard disk drive (HDD), a micro HDD, a solid-state disk drive (SSDD), flash memory cards (e.g., SD cards, microSD cards, xD picture cards, and the like), USB flash drives, on-die memory or registers associated with the processor circuitry 1102, resistance change memories, phase change memories, holographic memories, or chemical memories, and the like.

The storage circuitry 1108 is configured to store computational logic 1183 (or “modules 1183”) in the form of software, firmware, microcode, or hardware-level instructions to implement the techniques described herein. The computational logic 1183 may be employed to store working copies and/or permanent copies of programming instructions, or data to create the programming instructions, for the operation of various components of system 1100 (e.g., drivers, libraries, application programming interfaces (APIs), etc.), an OS of system 1100, one or more apps, and/or for carrying out the embodiments discussed herein. The computational logic 1183 may be stored or loaded into memory circuitry 1104 as instructions 1182, or data to create the instructions 1182, which are then accessed for execution by the processor circuitry 1102 to carry out the functions described herein. The processor circuitry 1102 accesses the memory circuitry 1104 and/or the storage circuitry 1108 over the interconnect (IX) 1106. The instructions 1182 to direct the processor circuitry 1102 to perform a specific sequence or flow of actions, for example, as described with respect to flowchart(s) and block diagram(s) of operations and functionality depicted previously. The various elements may be implemented by assembler instructions supported by processor circuitry 1102 or high-level languages that may be compiled into instructions 1181, or data to create the instructions 1181, to be executed by the processor circuitry 1102. The permanent copy of the programming instructions may be placed into persistent storage devices of storage circuitry 1108 in the factory or in the field through, for example, a distribution medium (not shown), through a communication interface (e.g., from a distribution server (not shown)), or over-the-air (OTA).

In some embodiments, the instructions 1181 on the processor circuitry 1102 (separately, or in combination with the instructions 1182 and/or logic/modules 1183 stored in computer-readable storage media) may configure execution or operation of a trusted execution environment (TEE) 1190. The TEE 1190 operates as a protected area accessible to the processor circuitry 1102 to enable secure access to data and secure execution of instructions. In some embodiments, the TEE 1190 may be a physical hardware device that is separate from other components of the system 1100 such as a secure-embedded controller, a dedicated SoC, or a tamper-resistant chipset or microcontroller with embedded processing devices and memory devices. Examples of such embodiments include a Desktop and mobile Architecture Hardware (DASH) compliant Network Interface Card (NIC), Intel® Management/Manageability Engine, Intel® Converged Security Engine (CSE) or a Converged Security Management/Manageability Engine (CSME), Trusted Execution Engine (TXE) provided by Intel® each of which may operate in conjunction with Intel® Active Management Technology (AMT) and/or Intel® vPro™ Technology; AMD® Platform Security coProcessor (PSP), AMD® PRO A-Series Accelerated Processing Unit (APU) with DASH manageability, Apple® Secure Enclave coprocessor; IBM® Crypto Express3®, IBM® 4807, 4808, 4809, and/or 4765 Cryptographic Coprocessors, IBM® Baseboard Management Controller (BMC) with Intelligent Platform Management Interface (IPMI), Dell™ Remote Assistant Card II (DRAC II), integrated Dell™ Remote Assistant Card (iDRAC), and the like.

In other embodiments, the TEE 1190 may be implemented as secure enclaves, which are isolated regions of code and/or data within the processor and/or memory/storage circuitry of the system 1100. Only code executed within a secure enclave may access data within the same secure enclave, and the secure enclave may only be accessible using the secure app (which may be implemented by an application processor or a tamper-resistant microcontroller). Various implementations of the TEE 1190, and an accompanying secure area in the processor circuitry 1102 or the memory circuitry 1104 and/or storage circuitry 1108 may be provided, for instance, through use of Intel® Software Guard Extensions (SGX), ARM® TrustZone® hardware security extensions, Keystone Enclaves provided by Oasis Labs™, and/or the like. Other aspects of security hardening, hardware roots-of-trust, and trusted or protected operations may be implemented in the device 1100 through the TEE 1190 and the processor circuitry 1102.

In some embodiments, the memory circuitry 1104 and/or storage circuitry 1108 may be divided into isolated user-space instances such as containers, partitions, virtual environments (VEs), etc. The isolated user-space instances may be implemented using a suitable OS-level virtualization technology such as Docker® containers, Kubernetes® containers, Solaris® containers and/or zones, OpenVZ® virtual private servers, DragonFly BSD® virtual kernels and/or jails, chroot jails, and/or the like. Virtual machines could also be used in some implementations. In some embodiments, the memory circuitry 1104 and/or storage circuitry 1108 may be divided into one or more trusted memory regions for storing apps or software modules of the TEE 1190.

The memory circuitry 1104 and/or storage circuitry 1108 may store program code of an operating system (OS), which may be a general purpose OS or an OS specifically written for and tailored to the computing platform 1100. For example, when the system 1100 is a server system or a desktop or laptop system 1100, the OS may be Unix or a Unix-like OS such as Linux e.g., provided by Red Hat Enterprise, Windows 10™ provided by Microsoft Corp.®, macOS provided by Apple Inc.®, or the like. In another example where the system 1100 is a mobile device, the OS may be a mobile OS, such as Android® provided by Google iOS® provided by Apple Inc.®, Windows 10 Mobile® provided by Microsoft Corp.®, KaiOS provided by KaiOS Technologies Inc., or the like. The OS manages computer hardware and software resources, and provides common services for various apps. The OS may include one or more drivers or APIs that operate to control particular devices that are embedded in the system 1100, attached to the system 1100, or otherwise communicatively coupled with the system 1100. The drivers may include individual drivers allowing other components of the system 1100 to interact or control various I/O devices that may be present within, or connected to, the system 1100. For example, the drivers may include a display driver to control and allow access to a display device, a touchscreen driver to control and allow access to a touchscreen interface of the system 1100, sensor drivers to obtain sensor readings of sensor circuitry 1121 and control and allow access to sensor circuitry 1121, actuator drivers to obtain actuator positions of the actuators 1122 and/or control and allow access to the actuators 1122, a camera driver to control and allow access to an embedded image capture device, audio drivers to control and allow access to one or more audio devices. The OSs may also include one or more libraries, drivers, APIs, firmware, middleware, software glue, etc., which provide program code and/or software components for one or more apps to obtain and use the data from other apps operated by the system 1100, such as the various subsystems of the CTS 150 discussed previously.

The components of system 1100 communicate with one another over the interconnect (IX) 1106. The IX 1106 may include any number of IX technologies such as industry standard architecture (ISA), extended ISA (EISA), inter-integrated circuit (I²C), serial peripheral interface (SPI), point-to-point interfaces, power management bus (PMBus), peripheral component interconnect (PCI), PCI express (PCIe), Intel® Ultra Path Interface (UPI), Intel® Accelerator Link (IAL), Common Application Programming Interface (CAPI), Intel® QuickPath Interconnect (QPI), Intel® Omni-Path Architecture (OPA) IX, RapidIO™ system interconnects, Ethernet, Cache Coherent Interconnect for Accelerators (CCIA), Gen-Z Consortium IXs, Open Coherent Accelerator Processor Interface (OpenCAPI), and/or any number of other IX technologies. The IX 1106 may be a proprietary bus, for example, used in a SoC based system.

The communication circuitry 1109 is a hardware element, or collection of hardware elements, used to communicate over one or more networks (e.g., network 1101) and/or with other devices. The communication circuitry 1109 includes modem 1110 and transceiver circuitry (“TRx”) 1112. The modem 1110 includes one or more processing devices (e.g., baseband processors) to carry out various protocol and radio control functions. Modem 1110 may interface with application circuitry of system 1100 (e.g., a combination of processor circuitry 1102, memory circuitry 1104, and/or storage circuitry 1108) for generation and processing of baseband signals and for controlling operations of the TRx 1112. The modem 1110 may handle various radio control functions that enable communication with one or more radio networks via the TRx 1112 according to one or more wireless communication protocols. The modem 1110 may include circuitry such as, but not limited to, one or more single-core or multi-core processors (e.g., one or more baseband processors) or control logic to process baseband signals received from a receive signal path of the TRx 1112, and to generate baseband signals to be provided to the TRx 1112 via a transmit signal path. In various embodiments, the modem 1110 may implement a real-time OS (RTOS) to manage resources of the modem 1110, schedule tasks, etc.

The communication circuitry 1109 also includes TRx 1112 to enable communication with wireless networks using modulated electromagnetic radiation through a non-solid medium. The TRx 1112 may include one or more radios that are compatible with, and/or may operate according to any one or more of the radio communication technologies, radio access technologies (RATs), and/or communication protocols/standards including any combination of those discussed herein. TRx 1112 includes a receive signal path, which comprises circuitry to convert analog RF signals (e.g., an existing or received modulated waveform) into digital baseband signals to be provided to the modem 1110. The TRx 1112 also includes a transmit signal path, which comprises circuitry configured to convert digital baseband signals provided by the modem 1110 to be converted into analog RF signals (e.g., modulated waveform) that will be amplified and transmitted via an antenna array including one or more antenna elements (not shown). The antenna array may be a plurality of microstrip antennas or printed antennas that are fabricated on the surface of one or more printed circuit boards. The antenna array may be formed in as a patch of metal foil (e.g., a patch antenna) in a variety of shapes, and may be coupled with the TRx 1112 using metal transmission lines or the like.

Network interface circuitry/controller (NIC) 1116 may be included to provide wired communication to the network 101 or to other devices using a standard network interface protocol. The standard network interface protocol may include Ethernet, Ethernet over GRE Tunnels, Ethernet over Multiprotocol Label Switching (MPLS), Ethernet over USB, or may be based on other types of network protocols, such as Controller Area Network (CAN), Local Interconnect Network (LIN), DeviceNet, ControlNet, Data Highway+, PROFIBUS, or PROFINET, among many others. Network connectivity may be provided to/from the system 1100 via NIC 1116 using a physical connection, which may be electrical (e.g., a “copper interconnect”) or optical. The physical connection also includes suitable input connectors (e.g., ports, receptacles, sockets, etc.) and output connectors (e.g., plugs, pins, etc.). The NIC 1116 may include one or more dedicated processors and/or FPGAs to communicate using one or more of the aforementioned network interface protocols. In some implementations, the NIC 1116 may include multiple controllers to provide connectivity to other networks using the same or different protocols. For example, the system 1100 may include a first NIC 1116 providing communications to the cloud over Ethernet and a second NIC 1116 providing communications to other devices over another type of network. In some implementations, the NIC 1116 may be a high-speed serial interface (HSSI) NIC to connect the system 1100 to a routing or switching device.

Network 1150 comprises computers, network connections among various computers (e.g., between the system 1100 and remote system 1155), and software routines to enable communication between the computers over respective network connections. In this regard, the network 1150 comprises one or more network elements that may include one or more processors, communications systems (e.g., including network interface controllers, one or more transmitters/receivers connected to one or more antennas, etc.), and computer readable media. Examples of such network elements may include wireless access points (WAPs), a home/business server (with or without radio frequency (RF) communications circuitry), a router, a switch, a hub, a radio beacon, base stations, picocell or small cell base stations, and/or any other like network device. Connection to the network 1150 may be via a wired or a wireless connection using the various communication protocols discussed infra. As used herein, a wired or wireless communication protocol may refer to a set of standardized rules or instructions implemented by a communication device/system to communicate with other devices, including instructions for packetizing/depacketizing data, modulating/demodulating signals, implementation of protocols stacks, and the like. More than one network may be involved in a communication session between the illustrated devices. Connection to the network 1150 may require that the computers execute software routines which enable, for example, the seven layers of the OSI model of computer networking or equivalent in a wireless (or cellular) phone network.

The network 1150 may represent the Internet, one or more cellular networks, a local area network (LAN) or a wide area network (WAN) including proprietary and/or enterprise networks, Transfer Control Protocol (TCP)/Internet Protocol (IP)-based network, or combinations thereof. In such embodiments, the network 1150 may be associated with network operator who owns or controls equipment and other elements necessary to provide network-related services, such as one or more base stations or access points, one or more servers for routing digital data or telephone calls (e.g., a core network or backbone network), etc. Other networks can be used instead of or in addition to the Internet, such as an intranet, an extranet, a virtual private network (VPN), an enterprise network, a non-TCP/IP based network, any LAN or WAN or the like.

The remote system 1155 (also referred to as a “service provider”, “application server(s)”, “app server(s)”, “external platform”, and/or the like) comprises one or more physical and/or virtualized computing systems owned and/or operated by a company, enterprise, and/or individual that hosts, serves, and/or otherwise provides information object(s) to one or more users (e.g., system 1100). The physical and/or virtualized systems include one or more logically or physically connected servers and/or data storage devices distributed locally or across one or more geographic locations. Generally, the remote system 1155 uses IP/network resources to provide information objects such as electronic documents, webpages, forms, apps (e.g., web apps), data, services, web services, media, and/or content to different user/client devices. As examples, the service provider 1155 may provide mapping and/or navigation services; cloud computing services; search engine services; social networking, microblogging, and/or message board services; content (media) streaming services; e-commerce services; blockchain services; communication services such as Voice-over-Internet Protocol (VoIP) sessions, text messaging, group communication sessions, and the like; immersive gaming experiences; and/or other like services. According to various embodiments, the remote system 1155 may correspond to the CTS 150 and provides contact tracing services. In these embodiments, the system 1100 may correspond to a user device 105, a GPO device 110, and/or an admin portal 120. The user/client devices (including GPO devices 110 and/or an admin portals 120) that utilize services provided by remote system 1155 may be referred to as “subscribers” or the like. Although FIG. 11 shows only a single remote system 1155, the remote system 1155 may represent multiple remote system 1155, each of which may have their own subscribing users.

The I/O interface circuitry 1118 is configured to connect or coupled the system 1100 with one or more external devices and/or subsystems. The external interface 1118 may include any suitable interface controllers and connectors to couple the system 1100 with the external components/devices. As an example, the external interface 1118 may be an external expansion bus (e.g., Universal Serial Bus (USB), FireWire, Thunderbolt, etc.) used to connect system 100 with external (peripheral) components/devices. The external devices include, inter alia, sensor circuitry 1121, actuators 1122, and positioning circuitry 1145, but may also include other devices or subsystems not shown by FIG. 11. In some cases, the I/O interface circuitry 1118 may be used to transfer data between the system 1100 and another computer device (e.g., a laptop, a smartphone, or some other user device) via a wired connection. I/O interface circuitry 1118 may include any suitable interface controllers and connectors to interconnect one or more of the processor circuitry 1102, memory circuitry 1104, storage circuitry 1108, communication circuitry 1109, and the other components of system 1100. The interface controllers may include, but are not limited to, memory controllers, storage controllers (e.g., redundant array of independent disk (RAID) controllers, baseboard management controllers (BMCs), input/output controllers, host controllers, etc. The connectors may include, for example, busses (e.g., IX 1106), ports, slots, jumpers, interconnect modules, receptacles, modular connectors, etc. The I/O interface circuitry 1118 may also include peripheral component interfaces including, but are not limited to, non-volatile memory ports, USB ports, audio jacks, power supply interfaces, on-board diagnostic (OBD) ports, etc.

The sensor circuitry 1121 may include devices, modules, or subsystems whose purpose is to detect events or changes in its environment and send the information (sensor data) about the detected events to some other device, module, subsystem, etc. Examples of such sensors 621 include, inter alia, inertia measurement units (IMU) comprising accelerometers, gyroscopes, and/or magnetometers; microelectromechanical systems (MEMS) or nanoelectromechanical systems (NEMS) comprising 3-axis accelerometers, 3-axis gyroscopes, and/or magnetometers; level sensors; flow sensors; temperature sensors (e.g., thermistors); pressure sensors; barometric pressure sensors; gravimeters; altimeters; image capture devices (e.g., cameras); light detection and ranging (LiDAR) sensors; proximity sensors (e.g., infrared radiation detector and the like), depth sensors, ambient light sensors, ultrasonic transceivers; microphones; etc.

The actuators 1122 allow the system 1100 to change its state, position, and/or orientation, or move or control a mechanism or system. The actuators 1122 comprise electrical and/or mechanical devices for moving or controlling a mechanism or system, and convert energy (e.g., electric current or moving air and/or liquid) into some kind of motion. The actuators 1122 may include one or more electronic (or electrochemical) devices, such as piezoelectric biomorphs, solid state actuators, solid state relays (SSRs), shape-memory alloy-based actuators, electroactive polymer-based actuators, relay driver integrated circuits (ICs), and/or the like. The actuators 1122 may include one or more electromechanical devices such as pneumatic actuators, hydraulic actuators, electromechanical switches including electromechanical relays (EMRs), motors (e.g., DC motors, stepper motors, servomechanisms, etc.), wheels, thrusters, propellers, claws, clamps, hooks, an audible sound generator, and/or other like electromechanical components. The system 1100 may be configured to operate one or more actuators 1122 based on one or more captured events and/or instructions or control signals received from a service provider and/or various client systems. In embodiments, the system 1100 may transmit instructions to various actuators 1122 (or controllers that control one or more actuators 1122) to reconfigure an electrical network as discussed herein.

The positioning circuitry 1145 includes circuitry to receive and decode signals transmitted/broadcasted by a positioning network of a GNSS. Examples of such navigation satellite constellations include United States' GPS, Russia's Global Navigation System (GLONASS), the European Union's Galileo system, China's BeiDou Navigation Satellite System, a regional navigation system or GNSS augmentation system (e.g., Navigation with Indian Constellation (NAVIC), Japan's Quasi-Zenith Satellite System (QZSS), France's Doppler Orbitography and Radio-positioning Integrated by Satellite (DORIS), etc.), or the like. The positioning circuitry 1145 comprises various hardware elements (e.g., including hardware devices such as switches, filters, amplifiers, antenna elements, and the like to facilitate OTA communications) to communicate with components of a positioning network, such as navigation satellite constellation nodes. In some embodiments, the positioning circuitry 1145 may include a Micro-Technology for Positioning, Navigation, and Timing (Micro-PNT) IC that uses a master timing clock to perform position tracking/estimation without GNSS assistance. The positioning circuitry 1145 may also be part of, or interact with, the communication circuitry 1109 to communicate with the nodes and components of the positioning network. The positioning circuitry 1145 may also provide position data and/or time data to the application circuitry, which may use the data to synchronize operations with various infrastructure (e.g., radio base stations), for turn-by-turn navigation, or the like.

The I/O device(s) 1140 may be present within, or connected to, the system 1100. The I/O devices 1140 include input device circuitry and output device circuitry including one or more user interfaces designed to enable user interaction with the system 1100 and/or peripheral component interfaces designed to enable peripheral component interaction with the system 1100. The input device circuitry includes any physical or virtual means for accepting an input including, inter alia, one or more physical or virtual buttons, a physical or virtual keyboard, keypad, mouse, touchpad, touchscreen, microphones, scanner, headset, and/or the like. In embodiments where the input device circuitry includes a capacitive, resistive, or other like touch-surface, a touch signal may be obtained from circuitry of the touch-surface. The touch signal may include information regarding a location of the touch (e.g., one or more sets of (x,y) coordinates describing an area, shape, and/or movement of the touch), a pressure of the touch (e.g., as measured by area of contact between a user's finger or a deformable stylus and the touch-surface, or by a pressure sensor), a duration of contact, any other suitable information, or any combination of such information. In these embodiments, one or more apps operated by the processor circuitry 1102 may identify gesture(s) based on the information of the touch signal, and utilizing a gesture library that maps determined gestures with specified actions.

The output device circuitry is used to show or convey information, such as sensor readings, actuator position(s), or other like information. Data and/or graphics may be displayed on one or more user interface components of the output device circuitry. The output device circuitry may include any number and/or combinations of audio or visual display, including, inter alia, one or more simple visual outputs/indicators (e.g., binary status indicators (e.g., light emitting diodes (LEDs)) and multi-character visual outputs, or more complex outputs such as display devices or touchscreens (e.g., Liquid Chrystal Displays (LCD), LED and/or OLED displays, quantum dot displays, projectors, etc.), with the output of characters, graphics, multimedia objects, and the like being generated or produced from operation of the system 1100. The output device circuitry may also include speakers or other audio emitting devices, printer(s), and/or the like. In some embodiments, the sensor circuitry 1121 may be used as the input device circuitry (e.g., an image capture device, motion capture device, or the like) and one or more actuators 1122 may be used as the output device circuitry (e.g., an actuator to provide haptic feedback or the like). In another example, near-field communication (NFC) circuitry 1146 comprising an NFC controller coupled with an antenna element and a processing device may be included to read electronic tags and/or connect with another NFC-enabled device. Peripheral component interfaces may include, but are not limited to, a non-volatile memory port, a universal serial bus (USB) port, an audio jack, a power supply interface, etc.

A battery 1124 may be coupled to the system 1100 to power the system 1100, which may be used in embodiments where the system 1100 is not in a fixed location, such as when the system 1100 is a mobile or laptop client system. The battery 1124 may be a lithium ion battery, a lead-acid automotive battery, or a metal-air battery, such as a zinc-air battery, an aluminum-air battery, a lithium-air battery, a lithium polymer battery, and/or the like. In embodiments where the system 1100 is mounted in a fixed location, such as when the system is implemented as a server computer system, the system 1100 may have a power supply coupled to an electrical grid. In these embodiments, the system 1100 may include power tee circuitry to provide for electrical power drawn from a network cable to provide both power supply and data connectivity to the system 1100 using a single cable.

Power management integrated circuitry (PMIC) 1126 may be included in the system 1100 to track the state of charge (SoCh) of the battery 1124, and to control charging of the system 1100. The PMIC 1126 may be used to monitor other parameters of the battery 1124 to provide failure predictions, such as the state of health (SoH) and the state of function (SoF) of the battery 1124. The PMIC 1126 may include voltage regulators, surge protectors, power alarm detection circuitry. The power alarm detection circuitry may detect one or more of brown out (under-voltage) and surge (over-voltage) conditions. The PMIC 1126 may communicate the information on the battery 1124 to the processor circuitry 1102 over the IX 1106. The PMIC 1126 may also include an analog-to-digital (ADC) convertor that allows the processor circuitry 1102 to directly monitor the voltage of the battery 1124 or the current flow from the battery 1124. The battery parameters may be used to determine actions that the system 1100 may perform, such as transmission frequency, mesh network operation, sensing frequency, and the like.

A power block 1128, or other power supply coupled to an electrical grid, may be coupled with the PMIC 1126 to charge the battery 1124. In some examples, the power block 1128 may be replaced with a wireless power receiver to obtain the power wirelessly, for example, through a loop antenna in the system 1100. In these implementations, a wireless battery charging circuit may be included in the PMIC 1126. The specific charging circuits chosen depend on the size of the battery 1124 and the current required.

NFC circuitry 1146 comprises one or more hardware devices and software modules configurable or operable to read electronic tags and/or connect with another NFC-enabled device (also referred to as an “NFC touchpoint”). NFC is commonly used for contactless, short-range communications based on radio frequency identification (RFID) standards, where magnetic field induction is used to enable communication between NFC-enabled devices. The one or more hardware devices may include an NFC controller coupled with an antenna element and a processor coupled with the NFC controller. The NFC controller may be a chip providing NFC functionalities to the NFC circuitry 1146. The software modules may include NFC controller firmware and an NFC stack. The NFC stack may be executed by the processor to control the NFC controller, and the NFC controller firmware may be executed by the NFC controller to control the antenna element to emit an RF signal. The RF signal may power a passive NFC tag (e.g., a microchip embedded in a sticker or wristband) to transmit stored data to the NFC circuitry 1146, or initiate data transfer between the NFC circuitry 1146 and another active NFC device (e.g., a smartphone or an NFC-enabled point-of-sale terminal) that is proximate to the computing system 1100 (or the NFC circuitry 1146 contained therein). The NFC circuitry 1146 may include other elements, such as those discussed herein. Additionally, the NFC circuitry 1146 may interface with a secure element (e.g., TEE 1190) to obtain payment credentials and/or other sensitive/secure data to be provided to the other active NFC device. Additionally or alternatively, the NFC circuitry 1146 and/or some other element may provide Host Card Emulation (HCE), which emulates a physical secure element.

The system 1100 may include any combinations of the components shown by FIG. 11; however, some of the components shown may be omitted, additional components may be present, and different arrangement of the components shown may occur in other implementations. In one example where the system 1100 is or is part of a server computer system, the battery 1124, communication circuitry 1109, the sensors 1121, actuators 1122, and/or POS 1145, and possibly some or all of the I/O devices 1140, may be omitted.

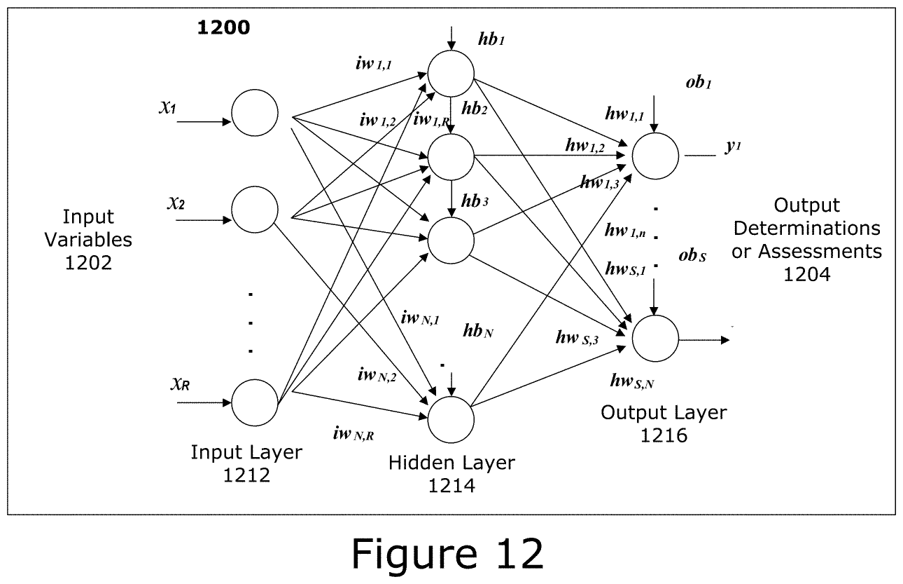

FIG. 12 illustrates an example NN 1200 suitable for use by the CTS and/or related services discussed previously according to various embodiments. NN 1200 may be suitable for use by one or more of the subsystems and/or the various embodiments disused herein, implemented in part by a hardware accelerator of the CTS or portions thereof.

The NN 1200 may represent one or more ML models that are trained using training data. The term “machine learning” or “ML” refers to the use of computer systems implementing algorithms and/or statistical models to perform specific task(s) without using explicit instructions, but instead relying on patterns and inferences. ML algorithms build or estimate mathematical model(s) (referred to as “ML models,” “models,” or the like) based on sample data (referred to as “training data,” “model training information,” or the like) in order to make predictions, inferences, or decisions. Generally, an ML algorithm is a computer program that learns from experience with respect to some task and some performance measure, and an ML model is any object or data structure created after an ML algorithm is trained with one or more training datasets. After training, an ML model may be used to make predictions on new datasets. Although the term “ML algorithm” refers to different concepts than the term “ML model,” these terms as discussed herein may be used interchangeably for the purposes of the present disclosure.

ML algorithms build or develop ML models using supervised learning (e.g., linear regression, k-nearest neighbor (KNN), decision tree algorithms, support machine vectors, Bayesian algorithm, ensemble algorithms, etc.), unsupervised learning (e.g., K-means clustering, principle component analysis (PCA), etc.), reinforcement learning (e.g., Q-learning, multi-armed bandit learning, deep RL, etc.), and the like. After the model is trained on some training data, the model can be used to process additional data to make predictions. The training may be supervised or unsupervised training depending on the particular ML algorithm used.

As shown, example NN 1200 may be a multi-layer feedforward NN (FNN) comprising an input layer 1212, one or more hidden layers 1214, and an output layer 1216. Input layer 1212 receives data of input variables (xᵢ) 1202. Hidden layer(s) 1214 processes the inputs, and eventually, output layer 1216 outputs the determinations or assessments (yᵢ) 1204. In one example implementation the input variables (xᵢ) 1202 of the NN are set as a vector containing the relevant variable data, while the output determination or assessment (yᵢ) 1204 of the NN are also as a vector. As an example, the multi-layer FNN 1200 may be expressed through the following equations:

hoᵢ=f(Σⱼ₌₁^{R}(iw_{i,j}xⱼ)+hbᵢ), for i=1, . . . ,N

yᵢ=f(Σₖ₌₁^{N}(hw_{i,k}hoₖ)+obᵢ), for i=1, . . . ,S

In the above equation, hoᵢ and yᵢ are the hidden layer variables and the final outputs, respectively; f( ) is typically a non-linear function, such as the sigmoid function or rectified linear (ReLu) function that mimics the neurons of the human brain; R is the number of inputs; N is the size of the hidden layer, or the number of neurons; and S is the number of the outputs.

In one example, the input variables (xᵢ) 1202 are set as a vector containing the relevant variable data, and the output determination or assessment (yᵢ) 1204 is also a vector. The input variables may be restricted to a limited set of quantifiable properties, which are referred to as “features.” In the context of ML, a feature is a user measureable property or characteristic of a phenomenon being observed. Features are usually represented using numbers/numerals (e.g., integers), strings, variables, ordinals, real-values, categories, Boolean values, and/or the like. A set of features may be referred to as a “feature vector.” A vector is a tuple of one or more values called scalars, and a feature vector may include a tuple of one or more features.

The goal of the FNN is to minimize an error function E between the network outputs and the desired targets, by adapting the network variables iw, hw, hb, and ob, via training, as follows:

E=Σₖ₌₁^{m}(Eₖ), where Eₖ=Σₚ₌₁^{S}=(tₖₚ−yₖₚ)²

In the above equation, yₖₚ and tₖₚ are the predicted and the target values of pth output unit for sample k, respectively, and m is the number of samples.

In one example, the input variables (xᵢ) 1202 may include various sensor (biometric) data collected by various sensors 1121, data collected from various sources as discussed herein, as well as data describing relevant factors to a decision. The output variables (yᵢ) 1204 may include a determined response. The network variables of the hidden layer(s) for the NN, are determined by the training data.

In the example of FIG. 12, for simplicity of illustration, there is only one hidden layer in the NN. In some other embodiments, there can be many hidden layers. Furthermore, the NN can be implemented using some other type of topology, such as a deep NN, deep FNN (DFN), convolution NN (CNN), deep CNN (DCN), deconvolutional NN (DNN), a deep belief NN, a perception NN, recurrent NN (RNN) such as a Long Short Term Memory (LSTM) algorithm and/or gated recurrent units (GRUs), and/or the like. In other embodiments, other ML techniques may be used such as deep learning matrix factorization algorithms, a deep stacking network, Markov chains, Bayesian Networks (BN), dynamic BNs (DBNs), Bayesian classifiers, Linear Dynamical Systems (LDS), Switching LDS (SLDS), k-nearest neighbor (kNN), logistic regression, decision trees, random forests, support vector machines (SVMs), among many others.

Furthermore, the embodiments of the present disclosure may take the form of a computer program product or data to create the computer program, with the computer program or data embodied in any tangible or non-transitory medium of expression having the computer-usable program code (or data to create the computer program) embodied in the medium.

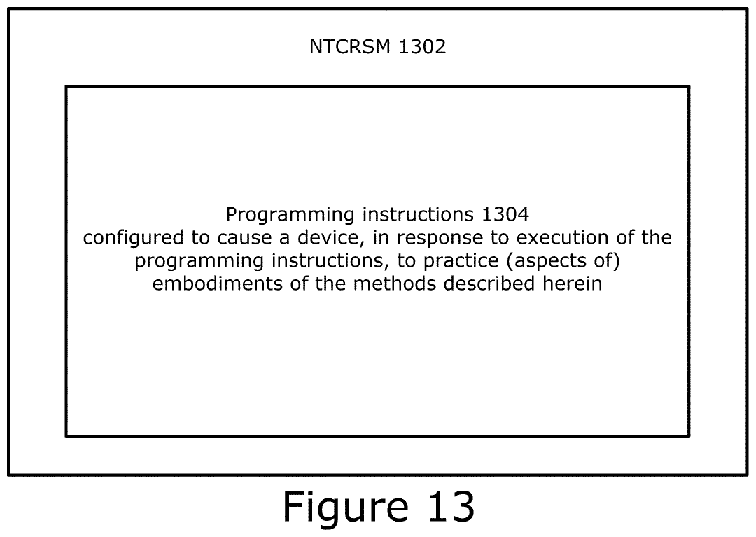

FIG. 13 illustrates an example non-transitory computer-readable storage media (NTCRSM) 1302 suitable for use to store instructions (or data that creates the instructions) that cause an apparatus (such as any of the devices/components/systems described with regard to FIGS. 1-12), in response to execution of the instructions by the apparatus, to practice selected aspects of the present disclosure. As shown, NTCRSM 1302 includes a number of programming instructions 1304 (or data to create the programming instructions). Programming instructions 1304 may be configured to enable a device (e.g., any of the devices/components/systems described with regard to FIGS. 1-12), in response to execution of the programming instructions 1304, to perform various programming operations associated with operating system functions, one or more apps, and/or aspects of the present disclosure (including various programming operations associated with FIGS. 1-12). In various embodiments, the programming instructions 1304 may correspond to any of the computational logic 1183, instructions 1182 and 1181 discussed previously with regard to FIG. 11.

Additionally or alternatively, programming instructions 1304 (or data to create the instructions 1304) may be disposed on multiple NTCRSM 1302. In alternate embodiments, programming instructions 1304 (or data to create the instructions 1304) may be disposed on computer-readable transitory storage media, such as signals. The programming instructions 1304 embodied by a machine-readable medium may be transmitted or received over a communications network using a transmission medium via a network interface device (e.g., communication circuitry 1109 and/or NIC 1116 of FIG. 11) utilizing any one of a number of transfer protocols (e.g., HTTP, etc.).

Any combination of one or more computer usable or computer readable media may be utilized as or instead of the NTCRSM 1302. The computer-usable or computer-readable medium may be, for example, but not limited to one or more electronic, magnetic, optical, electromagnetic, infrared, or semiconductor systems, apparatuses, devices, or propagation media. For instance, the NTCRSM 1302 may be embodied by devices described for the storage circuitry 1108 and/or memory circuitry 1104 described previously with regard to FIG. 11. More specific examples (a non-exhaustive list) of a computer-readable medium may include the following: an electrical connection having one or more wires, a portable computer diskette, a hard disk, a random access memory (RAM), a read-only memory (ROM), an erasable programmable read-only memory (EPROM, Flash memory, etc.), an optical fiber, a portable compact disc read-only memory (CD-ROM), an optical storage device and/or optical disks, a transmission media such as those supporting the Internet or an intranet, a magnetic storage device, or any number of other hardware devices. In the context of the present disclosure, a computer-usable or computer-readable medium may be any medium that can contain, store, communicate, propagate, or transport the program (or data to create the program) for use by or in connection with the instruction execution system, apparatus, or device. The computer-usable medium may include a propagated data signal with the computer-usable program code (e.g., including programming instructions 1304) or data to create the program code embodied therewith, either in baseband or as part of a carrier wave. The computer usable program code or data to create the program may be transmitted using any appropriate medium, including but not limited to wireless, wireline, optical fiber cable, RF, etc.

In various embodiments, the program code (or data to create the program code) described herein may be stored in one or more of a compressed format, an encrypted format, a fragmented format, a packaged format, etc. Program code (e.g., programming instructions 1304) or data to create the program code as described herein may require one or more of installation, modification, adaptation, updating, combining, supplementing, configuring, decryption, decompression, unpacking, distribution, reassignment, etc. in order to make them directly readable and/or executable by a computing device and/or other machine. For example, the program code or data to create the program code may be stored in multiple parts, which are individually compressed, encrypted, and stored on separate computing devices, wherein the parts when decrypted, decompressed, and combined form a set of executable instructions that implement the program code or the data to create the program code, such as those described herein. In another example, the program code or data to create the program code may be stored in a state in which they may be read by a computer, but require addition of a library (e.g., a dynamic link library), a software development kit (SDK), an API, etc. in order to execute the instructions on a particular computing device or other device. In another example, the program code or data to create the program code may need to be configured (e.g., settings stored, data input, network addresses recorded, etc.) before the program code or data to create the program code can be executed/used in whole or in part. In this example, the program code (or data to create the program code) may be unpacked, configured for proper execution, and stored in a first location with the configuration instructions located in a second location distinct from the first location. The configuration instructions can be initiated by an action, trigger, or instruction that is not co-located in storage or execution location with the instructions enabling the disclosed techniques. Accordingly, the disclosed program code or data to create the program code are intended to encompass such machine readable instructions and/or program(s) or data to create such machine readable instruction and/or programs regardless of the particular format or state of the machine readable instructions and/or program(s) when stored or otherwise at rest or in transit.

The computer program code for carrying out operations of the present disclosure, including, for example, programming instructions 1304, computational logic 1183, instructions 1182, and/or instructions 1181, may be written in any combination of one or more programming languages, including an object oriented programming language such as Python, PyTorch, Ruby, Scala, Smalltalk, Java™, Kotlin, C++, C#, or the like; a procedural programming language, such as the “C” programming language, the Go (or “Golang”) programming language, or the like; a scripting language such as JavaScript, Server-Side JavaScript (SSJS), PHP, Pearl, Python, PyTorch, Ruby or Ruby on Rails, Lua, Torch/Lua with Just-In Time compiler (LuaJIT), Accelerated Mobile Pages Script (AMPscript), VBScript, and/or the like; a markup language such as HTML, XML, wiki markup or Wikitext, Wireless Markup Language (WML), etc.; a data interchange format/definition such as Java Script Object Notion (JSON), Apache® MessagePack™, etc.; a stylesheet language such as Cascading Stylesheets (CSS), extensible stylesheet language (XSL), or the like; an interface definition language (IDL) such as Apache® Thrift, Abstract Syntax Notation One (ASN.1), Google® Protocol Buffers (protobuf), etc.; or some other suitable programming languages including proprietary programming languages and/or development tools, or any other languages or tools as discussed herein. The computer program code for carrying out operations of the present disclosure may also be written in any combination of the programming languages discussed herein. The program code may execute entirely on the system 1100, partly on the system 1100 as a stand-alone software package, partly on the system 1100 and partly on a remote computer (e.g., CTS 150), or entirely on the remote computer (e.g., CTS server(s) 155). In the latter scenario, the remote computer may be connected to the system 1100 through any type of network (e.g., network 1101).

The network 1101 may represent the Internet, one or more cellular networks, a LAN, a wide area network (WAN), a wireless LAN (WLAN), TCP/IP-based network, or combinations thereof. In some embodiments, the network 1101 may be associated with a network operator who owns or controls equipment and other elements necessary to provide network-related services, such as one or more base stations or access points, one or more servers for routing digital data or telephone calls (e.g., a core network or backbone network), etc. Other networks can be used instead of or in addition to the Internet, such as an intranet, an extranet, a virtual private network (VPN), a proprietary and/or enterprise network, a non-TCP/IP based network, and/or the like. The network 1101 comprises computers, network connections among various computers (e.g., between the client system(s), and CTS 150), and software routines to enable communication between the computers over respective network connections. In this regard, the network 1101 comprises one or more network elements that may include one or more processors, communications systems (e.g., including network interface controllers, one or more transmitters/receivers connected to one or more antennas, etc.), and computer readable media. Examples of such network elements may include wireless access points (WAPs), a home/business server (with or without radio frequency (RF) communications circuitry), a router, a switch, a hub, a radio beacon, base stations, picocell or small cell base stations, and/or any other like network device. Connection to the network 1101 may be via a wired or a wireless connection using the various communication protocols discussed infra. More than one network may be involved in a communication session between the illustrated devices. Connection to the network 1101 may require that the computers execute software routines that enable, for example, the seven layers of the OSI model of computer networking or equivalent in a wireless (or cellular) phone network.

### 3. Example Implementations

Additional examples of the presently described method, system, and device embodiments include the following, non-limiting implementations. Each of the following non-limiting examples may stand on its own or may be combined in any permutation or combination with any one or more of the other examples provided below or throughout the present disclosure.

Example A01 includes a mobile app to be operated by a client computing system, the mobile app comprising: means for displaying an MRE for contact tracing services.

Example A02 includes the system of example A01 and/or some other example(s) herein, wherein the mobile app is for use by a contact tracing participant, and the MRE is capable of being scanned or otherwise consumed by scanning means for recording entry and exit times at a particular gathering place.

Example A03 includes the system of example A01 and/or some other example(s) herein, wherein the mobile app is for use by a gathering place operator (GPO), and the mobile app further comprises: scanning means for scanning the MRE; and the means for displaying the MRE is for displaying the MRE after the MRE is scanned.

Example A04 includes the system of example A03 and/or some other example(s) herein, further comprising: means for communicating the scanned MRE and/or a unique identifier (UID) contained therein to a contact tracing service (CTS) for recording entry and exit times at a gathering place where the MRE is scanned.

Example AOS includes the system of examples A01-A04 and/or some other example(s) herein, further comprising means for registering with a contact tracing service (CTS) to obtain the MRE and/or the mobile app.

Example A06 includes a contact tracing service comprising: means for generating machine-readable elements (MREs) for individual contact tracing participants; means for receiving contact tracing information from GPOs based on scans of the MREs; and means for recording contact tracing information of the individual contact tracing participants.

Example A07 includes the system of example A06 and/or some other example(s) herein, further comprising: means for generating reports in response to queries received from contact tracers; and means for sending the generated reports to the contact tracers.

Example A08 includes the system of examples A06-A07 and/or some other example(s) herein, wherein the contact tracing service is implemented by a cloud computing service.

Example A09 includes the system of examples A01-A08 and/or some other example(s) herein, wherein the MRE is a quick response (QR) code.

Example X01 includes a hierarchical and modular solution to provide contact tracing for current and future pandemics, wherein the hierarchical and modular solution provides near-anonymity for users but also provides an audit trail for public health authorities.

Example X02 includes a unique machine-readable data structure providing system that records a participating individual's entry times and/or exit times at various locations.

Example X02.2 includes the system of examples X01-X02 and/or some other example(s) herein, wherein the system is further configurable or operable to collect vaccination data, and exclude individuals based on the vaccination data.

Example X02.4 includes the system of example X02.2 and/or some other example(s) herein, wherein the vaccination data includes or indicates one or more of whether an individual has been vaccinated (e.g., True or False), type of vaccine, vaccine manufacturer, dates of vaccination, whether the individual followed through on a second vaccination (if necessary), whether any booster shots were administered, location(s) where vaccine was administered, personnel who administered the vaccination, and/or the like.

Example X03 includes the system of examples X01-X02.4 and/or some other example(s) herein, wherein the system is further configurable or operable to manage access control.

Example X04 includes the system of examples X01-X03 and/or some other example(s) herein, wherein the system is further configurable or operable to scan in/out times at a gathering place without an ID, app, or phone.

Example X05 includes the system of examples X01-X04 and/or some other example(s) herein, wherein the system is further configurable or operable to scan in/out times at individual gathering locations unattended with an IoT hardware scanner.

Example X06 includes the system of examples X01-X05 and/or some other example(s) herein, wherein the system is further configurable or operable to record and display vaccination status, immunity, and/or disease status with the relevant data.

Example X07 includes the system of examples X01-X06 and/or some other example(s) herein, wherein the system is further configurable or operable to provide to public health authorities and other approved parties contact tracing statistics without using wireless communication network data (e.g., WiFi, LTE, or SG data) or other signaling data (e.g., GPS).

Example X08 includes the system of example X07 and/or some other example(s) herein, wherein the contact tracing statistics include or indicate who and how many individuals get infected where and when; how many contacts stay where how long and how often; which gathering places have the most infected; and how far and how soon an infected person spreads the disease.

Example X09 includes a comprehensive secure cloud architecture with a multi-layer protection of the data and the IT infrastructure that houses them.

Example X10 includes the system of example X09 and/or some other example(s) herein, wherein secure cloud architecture is configurable or operable to virtualize contact tracing services into a single portable unit, to cut cost and to simplify and speed up deployment.

Example X11 includes the system of example X10 and/or some other example(s) herein, wherein the single portable unit comprises a Solution In A Cloud and/or a Solution In A Box.

Example X12 includes the system of examples X01-X11 and/or some other example(s) herein, wherein the system is further configurable or operable to temporarily pause or remove a user as requested and to destroy all records after a certain period.

Example X13 includes the system of examples X01-X12 and/or some other example(s) herein, wherein the system is further configurable or operable to allow individual and gathering place users to register into the contact tracing system.

Example X14 includes the system of examples X01-X13 and/or some other example(s) herein, wherein the system is further configurable or operable to allow ability for users to be registered at locations in real time.

Example Z01 includes an apparatus comprising means to perform one or more elements of a method described in or related to any of examples A01-A09, X01-X14, or any other method or process described herein.

Example Z02 includes one or more non-transitory computer-readable media comprising instructions, wherein execution of the instructions by an electronic device is operable to cause the electronic device to perform one or more elements of a method described in or related to any of examples A01-A09, X01-X14, and/or any other method or process described herein.

Example Z03 includes a computer program comprising instructions, wherein execution of the program by a processing element is operable to cause the processing element to carry out the method, techniques, or process as described in or related to any of examples A01-A09, X01-X14, and/or portions thereof.

Example Z04 includes an apparatus comprising logic, modules, or circuitry to perform one or more elements of a method described in or related to any of examples A01-A09, X01-X14, and/or any other method or process described herein.

Example Z05 includes an apparatus configured to perform one or more elements of a method described in or related to any of examples A01-A09, X01-X14, and/or any other method or process described herein.

Example Z06 includes a method, technique, or process as described in or related to any of examples A01-A09, X01-X14, and/or portions or parts thereof.

Example Z06 includes an apparatus comprising: processor circuitry and computer-readable media comprising instructions, wherein the one or more processors are configurable to perform the method, techniques, or process as described in or related to any of examples A01-A09, X01-X14, and/or portions thereof.

Example Z07 includes a signal as described in or related to any of examples A01-A09, X01-X14, and/or portions or parts thereof.

Example Z08 includes a datagram, packet, frame, segment, protocol data unit (PDU), or message as described in or related to any of examples A01-A09, X01-X14, or portions or parts thereof, and/or otherwise described in the present disclosure.

Example Z09 includes a signal encoded with a datagram, packet, frame, segment, PDU, or message as described in or related to any of examples A01-A09, X01-X14, or portions or parts thereof, or otherwise described in the present disclosure.

Example Z10 includes a signal encoded with data as described in or related to any of examples A01-A09, X01-X14, or portions or parts thereof, or otherwise described in the present disclosure.

Example Z11 includes an electromagnetic signal carrying computer-readable instructions, wherein execution of the computer-readable instructions by one or more processors is operable or configurable to cause the one or more processors to perform a method, technique, or process as described in or related to any of examples A01-A09, X01-X14, or portions thereof.

Example Z12 includes an API or specification defining functions, methods, variables, data structures, protocols, etc., defining or involving use of any of examples A01-A09, X01-X14 or portions thereof, or otherwise related to any of examples A01-A09, X01-X14 or portions thereof.

### 4. Terminology

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C). Where the disclosure recites “a” or “a first” element or the equivalent thereof, such disclosure includes one or more such elements, neither requiring nor excluding two or more such elements. Further, ordinal indicators (e.g., first, second or third) for identified elements are used to distinguish between the elements, and do not indicate or imply a required or limited number of such elements, nor do they indicate a particular position or order of such elements unless otherwise specifically stated.

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous. Where the disclosure recites “a” or “a first” element or the equivalent thereof, such disclosure includes one or more such elements, neither requiring nor excluding two or more such elements. Further, ordinal indicators (e.g., first, second or third) for identified elements are used to distinguish between the elements, and do not indicate or imply a required or limited number of such elements, nor do they indicate a particular position or order of such elements unless otherwise specifically stated.

As used herein, the term “disease” refers to an abnormal condition that negatively affects the structure and/or function of an organism, which is not due to an acute external injury or trauma. The term “communicable disease” refers to an illness caused by an infectious agent or its toxins that occurs through direct or indirect transmission of the infectious agent or its products from an infected individual or via an animal, vector, or the inanimate environment to a susceptible animal or human host. The term “contagious” refers to a period doing which an individual is able to transmit an infectious agent or its toxins at a load sufficient to infect another individual.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or ink, and/or the like.

As used herein, the term “circuitry” refers to a circuit or system of multiple circuits configured to perform a particular function in an electronic device. The circuit or system of circuits may be part of or include one or more hardware components, such as a logic circuit, a processor (shared, dedicated, or group) and/or memory (shared, dedicated, or group) that are configured to provide the described functionality. In addition, the term “circuitry” may also refer to a combination of one or more hardware elements with the program code used to carry out the functionality of that program code. Some types of circuitry may execute one or more software or firmware programs to provide at least some of the described functionality. Such a combination of hardware elements and program code may be referred to as a particular type of circuitry. As used herein, the term “interface circuitry” may refer to, is part of, or includes circuitry providing for the exchange of information between two or more components or devices. The term “interface circuitry” may refer to one or more hardware interfaces (e.g., buses, input/output (I/O) interfaces, peripheral component interfaces, network interface cards, and/or the like).

As used herein, the term “module” may refer to one or more independent electronic circuits packaged onto a circuit board, System-on-Chip (SoC), System-in-Package (SiP), Multi-Chip-Package (MCP), etc., configured to provide a basic function within a computer system. The term “module” may refer to, be part of, or include an FPGA, ASIC, a processor (shared, dedicated, or group) and/or memory (shared, dedicated, or group) that execute one or more software or firmware programs, a combinational logic circuit, and/or other suitable components that provide the described functionality.

As used herein, the term “memory” may represent one or more hardware devices for storing data, including random access memory (RAM), magnetic RAM, core memory, read only memory (ROM), magnetic disk storage mediums, optical storage mediums, flash memory devices or other machine readable mediums for storing data. The term “computer-readable medium” may include, but is not limited to, memory, portable or fixed storage devices, optical storage devices, and various other mediums capable of storing, containing or carrying instructions or data. Example embodiments described herein may be implemented by computer hardware, software, firmware, middleware, microcode, hardware description languages, or any combination thereof. When implemented in software, firmware, middleware or microcode, the program code or code segments to perform the necessary tasks may be stored in a machine or computer readable medium. A code segment may represent a procedure, a function, a subprogram, a program, a routine, a subroutine, a module, program code, a software package, a class, or any combination of instructions, data structures, program statements, and/or any other type of computer-executable instructions or combinations thereof. The computer-executable instructions for the disclosed embodiments and implementations can be realized in any combination of one or more programming languages that can be executed on a computer system or like device such as, for example, an object oriented programming language such as Python, PyTorch, Ruby, Scala, Smalltalk, Java™, C++, C#, or the like; a procedural programming language, such as the “C” programming language, Go (or “Golang”), or the like; a scripting language such as JavaScript, Server-Side JavaScript (SSJS), PHP, Pearl, Python, PyTorch, Ruby or Ruby on Rails, Lua, Torch/Lua with Just-In Time compiler (LuaJIT), Accelerated Mobile Pages Script (AMPscript), VBScript, and/or the like; a markup language such as Hypertext Markup Language (HTML), Extensible Markup Language (XML), wiki markup or Wikitext, Wireless Markup Language (WML), etc.; a data interchange format/definition such as Java Script Object Notion (JSON), Apache® MessagePack™, etc.; a stylesheet language such as Cascading Stylesheets (CSS), extensible stylesheet language (XSL), or the like; an interface definition language (IDL) such as Apache® Thrift, Abstract Syntax Notation One (ASN.1), Google® Protocol Buffers (protobuf), etc.; or some other suitable programming languages including proprietary programming languages and/or development tools, or any other languages or tools as discussed herein.

As used herein, the terms “instantiate,” “instantiation,” and the like may refer to the creation of an instance, and an “instance” may refer to a concrete occurrence of an object, which may occur, for example, during execution of program code. Additionally, an “application instance” may be a realized software program executed in mobile edge host, which can provide service(s) to serve consumer(s). As used herein, the term “sampling” refers to a process of converting an analog signal into a number of data points at different times, and the term “quantization” refers to the number of data points used in a given sample.

As used herein, a “database object,” “data structure,” or the like may refer to any representation of information that is in the form of an object, attribute-value pair (AVP), key-value pair (KVP), tuple, etc., and may include variables, data structures, functions, methods, classes, database records, database fields, database entities, associations between data and/or database entities (also referred to as a “relation”), blocks and links between blocks in blockchain implementations, and/or the like. Data structures and/or database objects may be any suitable collection of data or information, and may comprise, for example, arrays, linked lists, multimaps, multisets, records, tuples, structs, containers, and/or the like. A “table” is a viewable representation of one or more database objects that are logically arranged as rows or records and include one or more data categories logically arranged as columns or fields. Each element of a table includes an instance of data for each category defined by the fields.

As used herein, the term “resource” refers to a physical or virtual device, a physical or virtual component within a computing environment, and/or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, webpages, web applications, and/or the like. The term “network resource” may refer to a resource hosted by a remote entity and accessible over a network. The term “system resources” may refer to any kind of shared entities to provide services, and may include computing and/or network resources. System resources may be considered as a set of coherent functions, network data objects or services, accessible through a server where such system resources reside on a single host or multiple hosts and are clearly identifiable. Additionally, a “virtualized resource” may refer to compute, storage, and/or network resources provided by virtualization infrastructure to an application, such as a mobile edge application.

As used herein, the term “content” refers to visual or audible information to be conveyed to a particular audience or end-user, and may include or convey information pertaining to specific subjects or topics. Content or content items may be different content types (e.g., text, image, audio, video, etc.), and/or may have different formats (e.g., text files including Microsoft® Word® documents, Portable Document Format (PDF) documents, HTML documents; audio files such as MPEG-4 audio files and WebM audio and/or video files; etc.). The term “document” may refer to a computer file or resource used to record data, and includes various file types or formats such as word processing, spreadsheet, slide presentation, multimedia items, and the like. As used herein, the term “service” refers to a particular functionality or a set of functions to be performed on behalf of a requesting party, such as any of the computing systems or devices discussed herein. A service may include or involve the retrieval of specified information or the execution of a set of operations.

As used herein, the term “communication protocol” (either wired or wireless) refers to a set of standardized rules or instructions implemented by a communication device and/or system to communicate with other devices and/or systems, including instructions for packetizing/depacketizing data, modulating/demodulating signals, implementation of protocols stacks, and/or the like. The various wireless communications discussed herein may include or be compatible with, but not limited to, any one or more of the following radio communication technologies and/or standards including: Global System for Mobile Communications (GSM), General Packet Radio Service (GPRS), Enhanced Data Rates for GSM Evolution (EDGE), and/or Third Generation Partnership Project (3GPP), for example, Universal Mobile Telecommunications System (UMTS), Freedom of Multimedia Access (FOMA), 3GPP Long Term Evolution (LTE), 3GPP Long Term Evolution Advanced (LTE Advanced), Code division multiple access 2000 (CDM2000), Cellular Digital Packet Data (CDPD), Mobitex, Third Generation (3G), Circuit Switched Data (CSD), High-Speed Circuit-Switched Data (HSCSD), Universal Mobile Telecommunications System (Third Generation) (UMTS (3G)), Wideband Code Division Multiple Access (Universal Mobile Telecommunications System) (W-CDMA (UMTS)), High Speed Packet Access (HSPA), High-Speed Downlink Packet Access (HSDPA), High-Speed Uplink Packet Access (HSUPA), High Speed Packet Access Plus (HSPA+), Universal Mobile Telecommunications System-Time-Division Duplex (UMTS-TDD), Time Division-Code Division Multiple Access (TD-CDMA), Time Division-Synchronous Code Division Multiple Access (TD-CDMA), 3rd Generation Partnership Project Release 8 (Pre-4th Generation) (3GPP Rel. 8 (Pre-4G)), 3GPP Rel. 9 (3rd Generation Partnership Project Release 9), 3GPP Rel. 10 (3rd Generation Partnership Project Release 10), 3GPP Rel. 11 (3rd Generation Partnership Project Release 11), 3GPP Rel. 12 (3rd Generation Partnership Project Release 12), 3GPP Rel. 8 (3rd Generation Partnership Project Release 8), 3GPP Rel. 14 (3rd Generation Partnership Project Release 14), 3GPP Rel. 15 (3rd Generation Partnership Project Release 15), 3GPP Rel. 16 (3rd Generation Partnership Project Release 16), 3GPP Rel. 17 (3rd Generation Partnership Project Release 17) and subsequent Releases (such as Rel. 18, Rel. 19, etc.), 3GPP 5G, 3GPP LTE Extra, LTE-Advanced Pro, LTE Licensed-Assisted Access (LAA), MuLTEfire, UMTS Terrestrial Radio Access (UTRA), Evolved UMTS Terrestrial Radio Access (E-UTRA), Long Term Evolution Advanced (4th Generation) (LTE Advanced (4G)), cdmaOne (2G), Code division multiple access 2000 (Third generation) (CDM2000 (3G)), Evolution-Data Optimized or Evolution-Data Only (EV-DO), Advanced Mobile Phone System (1st Generation) (AMPS (1G)), Total Access Communication System/Extended Total Access Communication System (TACS/ETACS), Digital AMPS (2nd Generation) (D-AMPS (2G)), Push-to-talk (PTT), Mobile Telephone System (MTS), Improved Mobile Telephone System (IMTS), Advanced Mobile Telephone System (AMTS), OLT (Norwegian for Offentlig Landmobil Telefoni, Public Land Mobile Telephony), MTD (Swedish abbreviation for Mobiltelefonisystem D, or Mobile telephony system D), Public Automated Land Mobile (Autotel/PALM), ARP (Finnish for Autoradiopuhelin, “car radio phone”), NMT (Nordic Mobile Telephony), High capacity version of NTT (Nippon Telegraph and Telephone) (Hicap), Cellular Digital Packet Data (CDPD), Mobitex, DataTAC, Integrated Digital Enhanced Network (iDEN), Personal Digital Cellular (PDC), Circuit Switched Data (CSD), Personal Handy-phone System (PHS), Wideband Integrated Digital Enhanced Network (WiDEN), iBurst, Unlicensed Mobile Access (UMA), also referred to as also referred to as 3GPP Generic Access Network, or GAN standard), Bluetooth®, Bluetooth Low Energy (BLE), IEEE 802.15.4 based protocols (e.g., IPv6 over Low power Wireless Personal Area Networks (6LoWPAN), WirelessHART, MiWi, Thread, I600.11a, etc.) WiFi-direct, ANT/ANT+, ZigBee, Z-Wave, 3GPP device-to-device (D2D) or Proximity Services (ProSe), Universal Plug and Play (UPnP), Low-Power Wide-Area-Network (LPWAN), LoRaWAN™ (Long Range Wide Area Network), Sigfox, Wireless Gigabit Alliance (WiGig) standard, mmWave standards in general (wireless systems operating at 10-300 GHz and above such as WiGig, IEEE 802.11ad, IEEE 802.11ay, etc.), technologies operating above 300 GHz and THz bands, (3GPP/LTE based or IEEE 802.11p and other) Vehicle-to-Vehicle (V2V) and Vehicle-to-X (V2X) and Vehicle-to-Infrastructure (V2I) and Infrastructure-to-Vehicle (I2V) communication technologies, 3GPP cellular V2X, DSRC (Dedicated Short Range Communications) communication systems such as Intelligent-Transport-Systems and others, the European ITS-G5 system (e.g., the European flavor of IEEE 802.11p based DSRC, including ITS-G5A (e.g., Operation of ITS-G5 in European ITS frequency bands dedicated to ITS for safety related applications in the frequency range 5,875 GHz to 5,905 GHz), ITS-G5B (e.g., Operation in European ITS frequency bands dedicated to ITS non-safety applications in the frequency range 5,855 GHz to 5,875 GHz), ITS-G5C (e.g., Operation of ITS applications in the frequency range 5,470 GHz to 5,725 GHz)), etc. In addition to the standards listed above, any number of satellite uplink technologies may be used for the TRx 1212 including, for example, radios compliant with standards issued by the ITU (International Telecommunication Union), or the ETSI (European Telecommunications Standards Institute), among others, both existing and not yet formulated.

As used herein, the term “device” may refer to a physical entity embedded inside, or attached to, another physical entity in its vicinity, with capabilities to convey digital information from or to that physical entity. As used herein, the term “element” may refer to a unit that is indivisible at a given level of abstraction and has a clearly defined boundary, wherein an element may be any type of entity. As used herein, the term “controller” may refer to an element or entity that has the capability to affect a physical entity, such as by changing its state or causing the physical entity to move. As used herein, the term “entity” may refer to a distinct component of an architecture or device, or information transferred as a payload.

As used herein, the term “computer system” refers to any type interconnected electronic devices, computer devices, or components thereof. Additionally, the term “computer system” and/or “system” may refer to various components of a computer that are communicatively coupled with one another, or otherwise organized to accomplish one or more functions. Furthermore, the term “computer system” and/or “system” may refer to multiple computer devices and/or multiple computing systems that are communicatively coupled with one another and configured to share computing and/or networking resources. Additionally, the terms “computer system” may be considered synonymous to, and may hereafter be occasionally referred to, as a computer device, computing device, computing platform, client device, client, mobile, mobile device, user equipment (UE), terminal, receiver, server, etc., and may describe any physical hardware device capable of sequentially and automatically carrying out a sequence of arithmetic or logical operations; equipped to record/store data on a machine readable medium; and transmit and receive data from one or more other devices in a communications network.

Examples of “computer devices,” “computer systems,” “user equipment,” etc. may include cellular phones or smartphones, feature phones, tablet personal computers, wearable computing devices, an autonomous sensors, laptop computers, desktop personal computers, video game consoles, digital media players, handheld messaging devices, personal data assistants, electronic book readers, augmented reality devices, server computer devices (e.g., stand-alone, rack-mounted, blade, etc.), cloud computing services/systems, network elements, in-vehicle infotainment (IVI), in-car entertainment (ICE) devices, an Instrument Cluster (IC), head-up display (HUD) devices, onboard diagnostic (OBD) devices, dashtop mobile equipment (DME), mobile data terminals (MDTs), Electronic Engine Management System (EEMS), electronic/engine control units (ECUs), electronic/engine control modules (EC Ms), embedded systems, microcontrollers, control modules, engine management systems (EMS), networked or “smart” appliances, machine-type communications (MTC) devices, machine-to-machine (M2M), Internet of Things (IoT) devices, and/or any other like electronic devices. Moreover, the term “vehicle-embedded computer device” may refer to any computer device and/or computer system physically mounted on, built in, or otherwise embedded in a vehicle.

The term “server” as used herein refers to a computing device or system, including processing hardware and/or process space(s), an associated storage medium such as a memory device or database, and, in some instances, suitable application(s) as is known in the art. The terms “server system” and “server” may be used interchangeably herein, and these terms refer to one or more computing system(s) that provide access to a pool of physical and/or virtual resources. The various servers discussed herein include computer devices with rack computing architecture component(s), tower computing architecture component(s), blade computing architecture component(s), and/or the like. The servers may represent a cluster of servers, a server farm, a cloud computing service, or other grouping or pool of servers, which may be located in one or more datacenters. The servers may also be connected to, or otherwise associated with, one or more data storage devices (not shown). Moreover, the servers may include an operating system (OS) that provides executable program instructions for the general administration and operation of the individual server computer devices, and may include a computer-readable medium storing instructions that, when executed by a processor of the servers, may allow the servers to perform their intended functions. Suitable implementations for the OS and general functionality of servers are known or commercially available, and are readily implemented by persons having ordinary skill in the art.

As used herein, the term “network element” may be considered synonymous to and/or referred to as a networked computer, networking hardware, network equipment, router, switch, hub, bridge, radio network controller, radio access network device, gateway, server, and/or any other like device. The term “network element” may describe a physical computing device of a wired or wireless communication network and be configured to host a virtual machine. Furthermore, the term “network element” may describe equipment that provides radio baseband functions for data and/or voice connectivity between a network and one or more users. The term “network element” may be considered synonymous to and/or referred to as a “base station.” As used herein, the term “base station” may be considered synonymous to and/or referred to as a node B, an enhanced or evolved node B (eNB), next generation nodeB (gNB), base transceiver station (BTS), access point (AP), roadside unit (RSU), etc., and may describe equipment that provides the radio baseband functions for data and/or voice connectivity between a network and one or more users. As used herein, the term “channel” may refer to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” may refer to a connection between two devices through a Radio Access Technology (RAT) for transmitting and receiving information.

The term “session” refers to a temporary and interactive information interchange between two or more communicating devices, two or more application instances, between a computer and user, or between any two or more entities or elements. Additionally or alternatively, the term “session” may refer to a connectivity service or other service that provides or enables the exchange of data between two entities or elements. A “network session” may refer to a session between two or more communicating devices over a network, and a “web session” may refer to a session between two or more communicating devices over the Internet. A “session identifier,” “session ID,” or “session token” refers to a piece of data that is used in network communications to identify a session and/or a series of message exchanges.

The term “network address” refers to an identifier for a node or host in a computer network, and may be a unique identifier across a network and/or may be unique to a locally administered portion of the network. Examples of network addresses include telephone numbers in a public switched telephone number, a cellular network address (e.g., international mobile subscriber identity (IMSI), mobile subscriber ISDN number (MSISDN), Subscription Permanent Identifier (SUPI), Temporary Mobile Subscriber Identity (TMSI), Globally Unique Temporary Identifier (GUTI), Generic Public Subscription Identifier (GPSI), etc.), an internet protocol (IP) address in an IP network (e.g., IP version 4 (Ipv4), IP version 6 (IPv6), etc.), an internet packet exchange (IPX) address, an X.25 address, an X.21 address, a port number (e.g., when using Transmission Control Protocol (TCP) or User Datagram Protocol (UDP)), a media access control (MAC) address, an Electronic Product Code (EPC) as defined by the EPCglobal Tag Data Standard, Bluetooth hardware device address (BD_ADDR), a Universal Resource Locator (URL), an email address, and/or the like.

The term “universally unique identifier” or “UUID” refers to a number used to identify information in computer systems. Usually, UUIDs are 128-bit numbers. UUIDs are generally represented as 32 hexadecimal digits displayed in five groups separated by hyphens in the following format: “xxxxxxxx-xxxx-Mxxx-Nxxx-xxxxxxxxxxxx” where the four-bit M and the 1 to 3 bit N fields code the format of the UUID itself. The term “universally unique identifier” or “UUID” may alternatively be referred to a “globally unique identifier” or “GUID”.

The term “information object” (or “InOb”) refers to a data structure that includes one or more data elements, each of which includes one or more data values. Examples of InObs include electronic documents, database objects, data files, resources, webpages, web forms, applications (e.g., web apps), services, web services, media, or content, and/or the like. InObs may be stored and/or processed according to a data format. Data formats define the content/data and/or the arrangement of data elements for storing and/or communicating the InObs. Each of the data formats may also define the language, syntax, vocabulary, and/or protocols that govern information storage and/or exchange. Examples of the data formats that may be used for any of the InObs discussed herein may include Accelerated Mobile Pages Script (AMPscript), Abstract Syntax Notation One (ASN.1), Backus-Naur Form (BNF), extended BNF, Bencode, BSON, ColdFusion Markup Language (CFML), comma-separated values (CSV), Control Information Exchange Data Model (C2IEDM), Cascading Stylesheets (CSS), DARPA Agent Markup Language (DAML), Document Type Definition (DTD), Electronic Data Interchange (EDI), Extensible Data Notation (EDN), Extensible Markup Language (XML), Efficient XML Interchange (EXI), Extensible Stylesheet Language (XSL), Free Text (FT), Fixed Word Format (FWF), Cisco® Etch, Franca, Geography Markup Language (GML), Guide Template Language (GTL), Handlebars template language, Hypertext Markup Language (HTML), Interactive Financial Exchange (IFX), Keyhole Markup Language (KML), JAMscript, Java Script Object Notion (JSON), JSON Schema Language, Apache® MessagePack™, Mustache template language, Ontology Interchange Language (OIL), Open Service Interface Definition, Open Financial Exchange (OFX), Precision Graphics Markup Language (PGML), Google® Protocol Buffers (protobuf), Quicken® Financial Exchange (QFX), Regular Language for XML Next Generation (RelaxNG) schema language, regular expressions, Resource Description Framework (RDF) schema language, RESTful Service Description Language (RSDL), Scalable Vector Graphics (SVG), Schematron, Tactical Data Link (TDL) format (e.g., J-series message format for Link 16; JREAP messages; Multifuction Advanced Data Link (MADL), Integrated Broadcast Service/Common Message Format (IBS/CMF), Over-the-Horizon Targeting Gold (OTH-T Gold), Variable Message Format (VMF), United States Message Text Format (USMTF), and any future advanced TDL formats), VBScript, Web Application Description Language (WADL), Web Ontology Language (OWL), Web Services Description Language (WSDL), wiki markup or Wikitext, Wireless Markup Language (WML), extensible HTML (XHTML), XPath, XQuery, XML DTD language, XML Schema Definition (XSD), XML Schema Language, XSL Transformations (XSLT), YAML (“Yet Another Markup Language” or “YANL Ain't Markup Language”), Apache® Thrift, and/or any other data format and/or language discussed elsewhere herein.

Additionally or alternatively, the data format for the InObs may be document and/or plain text, spreadsheet, graphics, and/or presentation formats including, for example, American National Standards Institute (ANSI) text, a Computer-Aided Design (CAD) application file format (e.g., “.c3d”, “.dwg”, “.dft”, “.iam”, “.iaw”, “.tct”, and/or other like file extensions), Google® Drive® formats (including associated formats for Google Docs®, Google Forms®, Google Sheets®, Google Slides®, etc.), Microsoft® Office® formats (e.g., “.doc”, “.ppt”, “.xls”, “.vsd”, and/or other like file extension), OpenDocument Format (including associated document, graphics, presentation, and spreadsheet formats), Open Office XML (OOXML) format (including associated document, graphics, presentation, and spreadsheet formats), Apple® Pages®, Portable Document Format (PDF), Question Object File Format (QUOX), Rich Text File (RTF), TeX and/or LaTeX (“.tex” file extension), text file (TXT), TurboTax® file (“.tax” file extension), You Need a Budget (YNAB) file, and/or any other like document or plain text file format.

Additionally or alternatively, the data format for the InObs may be archive file formats that store metadata and concatenate files, and may or may not compress the files for storage. As used herein, the term “archive file” refers to a file having a file format or data format that combines or concatenates one or more files into a single file or InOb. Archive files often store directory structures, error detection and correction information, arbitrary comments, and sometimes use built-in encryption. The term “archive format” refers to the data format or file format of an archive file, and may include, for example, archive-only formats that store metadata and concatenate files, for example, including directory or path information; compression-only formats that only compress a collection of files; software package formats that are used to create software packages (including self-installing files), disk image formats that are used to create disk images for mass storage, system recovery, and/or other like purposes; and multi-function archive formats that can store metadata, concatenate, compress, encrypt, create error detection and recovery information, and package the archive into self-extracting and self-expanding files. For the purposes of the present disclosure, the term “archive file” may refer to an archive file having any of the aforementioned archive format types. Examples of archive file formats may include Android® Package (APK); Microsoft® Application Package (APPX); Genie Timeline Backup Index File (GBP); Graphics Interchange Format (GIF); gzip (.gz) provided by the GNU Project™; Java® Archive (JAR); Mike O'Brien Pack (MPQ) archives; Open Packaging Conventions (OPC) packages including OOXML files, OpenXPS files, etc.; Rar Archive (RAR); Red Hat® package/installer (RPM); Google® SketchUp backup File (SKB); TAR archive (“.tar”); XPInstall or XPI installer modules; ZIP (.zip or .zipx); and/or the like.

The term “data element” refers to an atomic state of a particular object with at least one specific property at a certain point in time, and may include one or more of a data element name or identifier, a data element definition, one or more representation terms, enumerated values or codes (e.g., metadata), and/or a list of synonyms to data elements in other metadata registries. Additionally or alternatively, a “data element” may refer to a data type that contains one single data. Data elements may store data, which may be referred to as the data element's content (or “content items”). Content items may include text content, attributes, properties, and/or other elements referred to as “child elements.” Additionally or alternatively, data elements may include zero or more properties and/or zero or more attributes, each of which may be defined as database objects (e.g., fields, records, etc.), object instances, and/or other data elements. An “attribute” may refer to a markup construct including a name-value pair that exists within a start tag or empty element tag. Attributes contain data related to its element and/or control the element's behavior.

The term “personal data,” “personally identifiable information,” “PII,” or the like refers to information that relates to an identified or identifiable individual. Additionally or alternatively, “personal data,” “personally identifiable information,” “PII,” or the like refers to information that can be used on its own or in combination with other information to identify, contact, or locate a person, or to identify an individual in context. The term “sensitive data” may refer to data related to racial or ethnic origin, political opinions, religious or philosophical beliefs, or trade union membership, genetic data, biometric data, data concerning health, and/or data concerning a natural person's sex life or sexual orientation. The term “confidential data” refers to any form of information that a person or entity is obligated, by law or contract, to protect from unauthorized access, use, disclosure, modification, or destruction. Additionally or alternatively, “confidential data” may refer to any data owned or licensed by a person or entity that is not intentionally shared with the general public or that is classified by the person or entity with a designation that precludes sharing with the general public.

The term “pseudonymization” or the like refers to any means of processing personal data or sensitive data in such a manner that the personal/sensitive data can no longer be attributed to a specific data subject (e.g., person or entity) without the use of additional information. The additional information may be kept separately from the personal/sensitive data and may be subject to technical and organizational measures to ensure that the personal/sensitive data are not attributed to an identified or identifiable natural person.

The term “organization” or “org” refers to an entity comprising one or more people and/or users and having a particular purpose, such as, for example, a company, an enterprise, an institution, an association, a regulatory body, a government agency, a standards body, etc. Additionally or alternatively, an “org” may refer to an identifier that represents an entity/organization and associated data within an instance and/or data structure.

In the present description, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the detailed description is not to be taken in a limiting sense, and the scope of embodiments is defined by the appended claims and their equivalents.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Also, it is noted that example embodiments may be described as a process depicted as successive operations and/or with a flowchart, a flow diagram, a data flow diagram, a structure diagram, or a block diagram. Although a flowchart may describe the operations as a sequential process, many of the operations may be performed in parallel, concurrently, or simultaneously. In addition, the order of the operations may be re-arranged. A process may be terminated when its operations are completed, but may also have additional steps not included in a figure. A process may correspond to a method, a function, a procedure, a subroutine, a subprogram, and the like. When a process corresponds to a function, its termination may correspond to a return of the function to the calling function or a main function.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein. Therefore, it is manifestly intended that embodiments described herein be limited only by the claims.

1. One or more non-transitory computer-readable media (NTCRM) comprising instructions for providing contact tracing services (CTS), wherein execution of the instructions by one or more processors of a computing system is to cause the computing system to:
obtain personally identifiable information (PII) from a user system via a CTS portal;
generate a unique identifier (UID);
store, in a contact tracing database, the generated UID in association with the PII;
generate a machine-readable element (MRE) based at least in part on a portion of the UID;
generate a message including the MRE; and
send the message to the user system to be used for consuming the CTS.

2. The one or more NTCRM of claim 1, wherein execution of the instructions is to further cause the computing system to:
encode the generated UID in the MRE.

3. The one or more NTCRM of claim 1, wherein execution of the instructions is to further cause the computing system to:
receive a message from a gathering place operator (GPO) device, the message including an extracted UID from a scanned MRE and a timestamp indicating a time of the MRE scan; and
store, in the contact tracing database, a record including the extracted UID, the timestamp, and a gathering place identifier (ID) associated with the GPO device.

4. The one or more NTCRM of claim 3, wherein execution of the instructions is to further cause the computing system to:
generate a presumed or estimated timestamp when another message is not received from the GPO device within a predefined amount of time after receipt of the message; and
store, in the contact tracing database, another record including the extracted UID, the presumed or estimated timestamp, and the gathering place ID associated with the GPO device.

5. The one or more NTCRM of claim 3, wherein execution of the instructions is to further cause the computing system to:
receive a CTS query including a UID of a case subject;
obtain each case subject record from the contact tracing database, each case subject record being records including the UID;
obtain additional records including gathering place IDs that are also included in each case subject record;
generate a report including each case subject record and each obtained additional record; and
send the report to a device from which the CTS query was received.

6. The one or more NTCRM of claim 5, wherein, for each case subject record, execution of the instructions is to further cause the computing system to:
obtain only the additional records having a timestamp within a predefined amount of time as timestamps included in each case subject record.

7. The one or more NTCRM of claim 5, wherein, for each case subject record, execution of the instructions is to further cause the computing system to:
obtain only the additional records having a timestamp between timestamps included in case subject records having a same gathering place ID.

8. The one or more NTCRM of claim 1, wherein the PII only includes an email address.

9. The one or more NTCRM of claim 1, wherein the PII includes one or more of an email address, a first and last name, a physical address, and a phone number.

10. The one or more NTCRM of claim 1, wherein execution of the instructions is to further cause the computing system to:
generate the UID using at least a portion of the PII; or
generate the UID using a random number generation mechanism based on a time at which the PII is received.

11. The one or more NTCRM of claim 1, wherein:
the MRE comprises a linear barcode, a quick response (QR) code, an Electronic Bar Code (EPC), an image with a watermark as the UID, an image steganographically including the UID, or a signal encoded with the UID; and
the UID comprises a randomly generated number or string, the PII, an encryption technique based on the PII, a user ID, an encryption technique based on the user ID, a digital certificate, a digital signature, a network address, an encryption technique based on the network address, a device fingerprint of the user system, or biometric data.

12. The one or more NTCRM of claim 3, wherein execution of the instructions is to further cause the computing system to:
operate a machine learning model to predict one or more infection or contamination hotspots based on a set of records in the contact tracing database, wherein each record of the set of records includes respective UIDs, location data, and timestamp data, and each infection or contamination hotspot of the one or more hotspots indicates one or more of a predicted future area of infection or contamination, rate of infection or contamination, and a speed of infection or contamination.

13. The one or more NTCRM of claim 1, wherein the computing system comprises one or more application servers or one or more cloud compute nodes of a cloud computing service.

14. An apparatus to be employed as a gathering place operator (GPO) computer device, the apparatus comprising:
memory circuitry arranged to store program code of a contact tracing service (CTS) application (app); and
processor circuitry communicatively coupled with the memory circuitry, the processor circuitry arranged to operated the CTS app to:
cause the GPO computer device to scan a machine-readable element (MRE);
extract a unique identifier (UID) from the scanned MRE;
generate a timestamp of a time at which the scan occurred;
generate a message including the UID and the timestamp for recording an entry or exit time at a gathering place where the CTS app is being operated; and
send the message to a CTS system for recordation of the UID and the timestamp.

15. The apparatus of claim 14, wherein the MRE is displayed by display device of a mobile device.

16. The apparatus of claim 14, wherein, to cause the GPO computer device to scan the MRE, the processor circuitry arranged to operate the CTS app to:
invoke or call a driver or application programming interface (API) for accessing an image sensor of the GPO computer device.

17. The apparatus of claim 14, the processor circuitry arranged to operate the CTS app to:
display the MRE on a display of the GPO computer device after the MRE is scanned.

18. The apparatus of claim 14, wherein the UID is a version 4 Universally Unique Identifier (UUID) or a hash value calculated using at least a portion of personally identifiable information (PII) of a user providing the MRE.

19. The apparatus of claim 14, wherein the MRE is a linear barcode, a quick response (QR) code, an Electronic Bar Code (EPC), an image with a watermark, an image steganographically including the UID, a radio frequency identification (RFID) tag signal, a Bluetooth signal, or a near-field communication (NFC) signal.

20. The apparatus of claim 14, wherein the GPO computer device is a smartphone, a tablet computer, a point of sale (POS) terminal, an RFID reader, a Bluetooth beacon, an NFC reader, or an Internet of Things (IoT) device including one or more of an RFID reader, Bluetooth beacon, of an NFC reader.

21. A method for operating a contact tracing service (CTS) application (app) provided by a CTS, the method comprising:
submitting, by a mobile device, personally identifiable information (PII) to the CTS via a CTS portal accessed using the CTS app;
obtaining, by the mobile device, a machine-readable element (MRE) encoded with unique identifier (UID) generated by the CTS for the mobile device; and
displaying the QR code to be scanned by a gathering place operator (GPO) device.

22. The method of claim 21, wherein the PII only includes a network address of the mobile device.

23. The method of claim 21, wherein the PII only includes an email address.

24. The method of claim 21, wherein the MRE is a linear barcode, a quick response (QR) code, an Electronic Bar Code (EPC), an image with a watermark as the UID, an image steganographically including the UID, a signal encoded with the UID; and the UID is a version 4 Universally Unique Identifier (UUID).

25. The method of claim 24, further comprising:
generating, by the mobile device in response to a user input via the CTS app, a message indicating to delete the UID; and
sending, by the mobile device, the message to the CTS via the CTS portal.
